(19) United States
(12) Patent Application Publication
(10) Pub. No.: US 2025/0253880 A1
(43) Pub. Date: Aug. 7, 2025

(54) WIRELESS TRANSCEIVER INFORMATION PROVISIONING SYSTEM

(71) Applicant: Dell Products L.P., Round Rock, TX (US)

(72) Inventors: Padmanabhan Narayanan, Chennai (IN); Shree Rathinasamy, Georgetown, TX (US); Neal Beard, Austin, TX (US)

(21) Appl. No.: 18/802,088

(22) Filed: Aug. 13, 2024

Related U.S. Application Data
(63) Continuation-in-part of application No. 18/435,141, filed on Feb. 7, 2024.

(51) Int. Cl. H04B 1/3827; H04B 1/40

(52) U.S. Cl. CPC H04B 1/3827; H04B 1/40

(57) ABSTRACT

A wireless transceiver information provisioning device includes a wireless transceiver information provisioning device chassis, a transceiver device connector on the wireless transceiver information provisioning device chassis that is connected to a wireless transceiver information provisioning device connector on a transceiver device that is connected to a port, and a wireless communication subsystem housed in the wireless transceiver information provisioning device chassis and coupled to the transceiver device connector. The wireless communication subsystem receives transceiver information associated with the transceiver device via the transceiver device connector, and stores the first transceiver information. When the wireless communication subsystem wirelessly subsequently receives a transceiver information request from a wireless device, it wirelessly transmit the transceiver information to the wireless device.

### BACKGROUND

The present application is a continuation-in-part of U.S. patent application Ser. No. 18/435,141, attorney docket no. 135748.01, filed Feb. 7, 2024, the disclosure of which is incorporated by reference herein in its entirety.

### BACKGROUND

The present disclosure relates generally to information handling systems, and more particularly to wirelessly providing information associated with a transceiver device connected to an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switch devices and/or other networking devices known in the art, sometimes use transceiver devices (e.g., Quad Small Form-factor Pluggable (QSFP) transceiver devices) to transmit data. In many situations, it is desirable to retrieve information about a transceiver device connected to a networking device, which may include details about the transceiver device, detail about the port the transceiver device is connected to, details about the networking device the transceiver device is connected to, and/or other transceiver information known in the art. For example, providing a link using transceiver devices, confirming a link provided using a transceiver device is a desired link (i.e., as per a wiring plan), troubleshooting issues with a link provided using transceiver devices, and/or other situations may require (or may be greatly simplified) by retrieving the transceiver information discussed above.

Conventional techniques for receiving such transceiver information require a user to access a management device that is connected to the networking device via a network and an out-of-band connection, log into the networking device via the network, and then interact with the networking device via the network using the management device to retrieve the transceiver information. However, as the number of transceiver devices, port configurations, operating systems, and management interfaces supported by networking devices increases, difficulties associated with the retrieval of transceiver information increases as well, particularly when a network administrator or other user doing so works in time-constrained and/or physically constrained environment and are not trained for (or are otherwise unfamiliar with) the networking devices, transceiver devices, operating systems, management devices, and/or other components required to retrieve transceiver information.

Accordingly, it would be desirable to provide a transceiver information provisioning system that addresses the issues discussed above.

### SUMMARY

According to one embodiment, a wireless transceiver information provisioning system includes a computing device including a first port; a first transceiver device that is connected to the first port and that includes a first wireless transceiver information provisioning device connector; and a first wireless transceiver information provisioning device that includes a transceiver device connector that is connected to the first wireless transceiver information provisioning device connector, wherein the wireless transceiver information provisioning device is configured to: receive, via the transceiver device connector, first transceiver information associated with the first transceiver device; store the first transceiver information; wirelessly receive, from a first wireless device, a transceiver information request; and wirelessly transmit, to the first wireless device in response to receiving the transceiver information request, the first transceiver information.

### BRIEF DESCRIPTION OF THE DRAWINGS

FIG. 1 is a schematic view illustrating an embodiment of an Information Handling System (IHS).

FIG. 2 is a schematic view illustrating an embodiment of a networking device that may be included in the wireless transceiver information provisioning system of the present disclosure.

FIG. 3A is a side view illustrating an embodiment of a transceiver device that may be included in the wireless transceiver information provisioning system of the present disclosure.

FIG. 3B is a rear view illustrating an embodiment of the transceiver device of FIG. 3A.

FIG. 3C is a schematic view illustrating an embodiment of the transceiver device of FIGS. 3A and 3B.

FIG. 4A is a front perspective view illustrating an embodiment of wireless transceiver information provisioning device that may be included in the wireless transceiver information provisioning system of the present disclosure.

FIG. 4B is a rear perspective view illustrating an embodiment of the wireless transceiver information provisioning device of FIG. 4A.

FIG. 4C is a rear view illustrating an embodiment of the wireless transceiver information provisioning device of FIGS. 4A and 4B.

FIG. 4D is a side view illustrating an embodiment of the wireless transceiver information provisioning device of FIGS. 4A, 4B, and 4C.

FIG. 4E is a schematic view illustrating an embodiment of the transceiver device of FIGS. 4A, 4B, 4C, and 4D.

FIG. 5 is a flow chart illustrating an embodiment of a method for wirelessly providing information about a transceiver device.

FIG. 6 is a side view illustrating an embodiment of the transceiver device of FIGS. 3A-3C connected to the networking device of FIG. 2, and the wireless transceiver information provisioning device of FIGS. 4A-4E connected to the transceiver device, to provide a wireless transceiver information provisioning system during the method of FIG. 5.

FIG. 7 is a schematic view illustrating an embodiment of the transceiver device of FIGS. 3A-3C connected to the networking device of FIG. 2, and the wireless transceiver information provisioning device of FIGS. 4A-4E connected to the transceiver device, to provide a wireless transceiver information provisioning system during the method of FIG. 5.

FIG. 8 is a schematic view illustrating an embodiment of the wireless transceiver information provisioning system of FIG. 7 operating during the method of FIG. 5.

FIG. 9 is a schematic view illustrating an embodiment of the wireless transceiver information provisioning system of FIG. 7 operating during the method of FIG. 5.

FIG. 10 is a schematic view illustrating an embodiment of the wireless transceiver information provisioning system of FIG. 7 operating during the method of FIG. 5.

FIG. 11 is a schematic view illustrating an embodiment of the wireless transceiver information provisioning system of FIG. 7 operating during the method of FIG. 5.

FIG. 12 is a schematic view illustrating an embodiment of the wireless transceiver information provisioning system of FIG. 6 operating during the method of FIG. 5.

FIG. 13 is a schematic view illustrating an embodiment of the wireless transceiver information provisioning system of FIG. 6 operating during the method of FIG. 5.

FIG. 14 is a schematic view illustrating an embodiment of the wireless transceiver information provisioning system of FIG. 6 operating during the method of FIG. 5.

FIG. 15 is a schematic view illustrating an embodiment of a pair of the wireless transceiver information provisioning systems of FIG. 6 operating during the method of FIG. 5.

FIG. 16 is a schematic view illustrating an embodiment of a pair of the wireless transceiver information provisioning systems of FIG. 6 operating during the method of FIG. 5.

FIG. 17 is a schematic view illustrating an embodiment of a pair of the wireless transceiver information provisioning systems of FIG. 6 operating during the method of FIG. 5.

FIG. 18 is a schematic view illustrating an embodiment of a pair of the wireless transceiver information provisioning systems of FIG. 6 operating during the method of FIG. 5.

FIG. 19 is a schematic view illustrating an embodiment of a pair of the wireless transceiver information provisioning systems of FIG. 6 operating during the method of FIG. 5.

FIG. 20 is a schematic view illustrating an embodiment of a pair of the wireless transceiver information provisioning systems of FIG. 6 operating as a result of the method of FIG. 5.

FIG. 21 is a schematic view illustrating an embodiment of the wireless transceiver information provisioning system of FIG. 7 operating as a result of the method of FIG. 5.

FIG. 22A is a schematic view illustrating an embodiment of the wireless transceiver information provisioning system of FIG. 7 operating as a result of the method of FIG. 5.

FIG. 22B is a schematic view illustrating an embodiment of a pair of the wireless transceiver information provisioning systems of FIG. 6 operating as a result of the method of FIG. 5.

FIG. 22C is a schematic view illustrating an embodiment of the wireless transceiver information provisioning system of FIG. 7 operating as a result of the method of FIG. 5.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

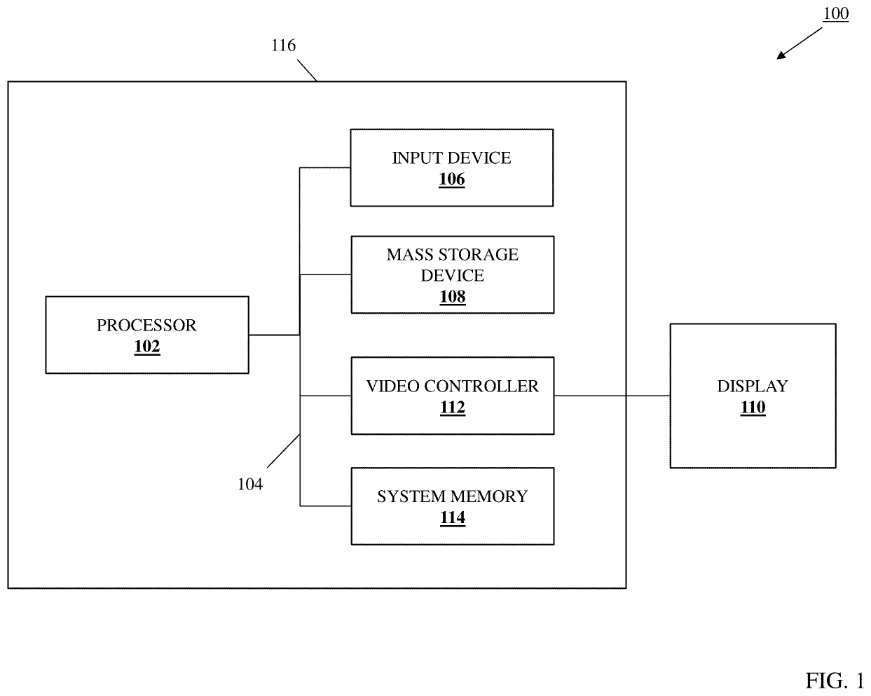

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

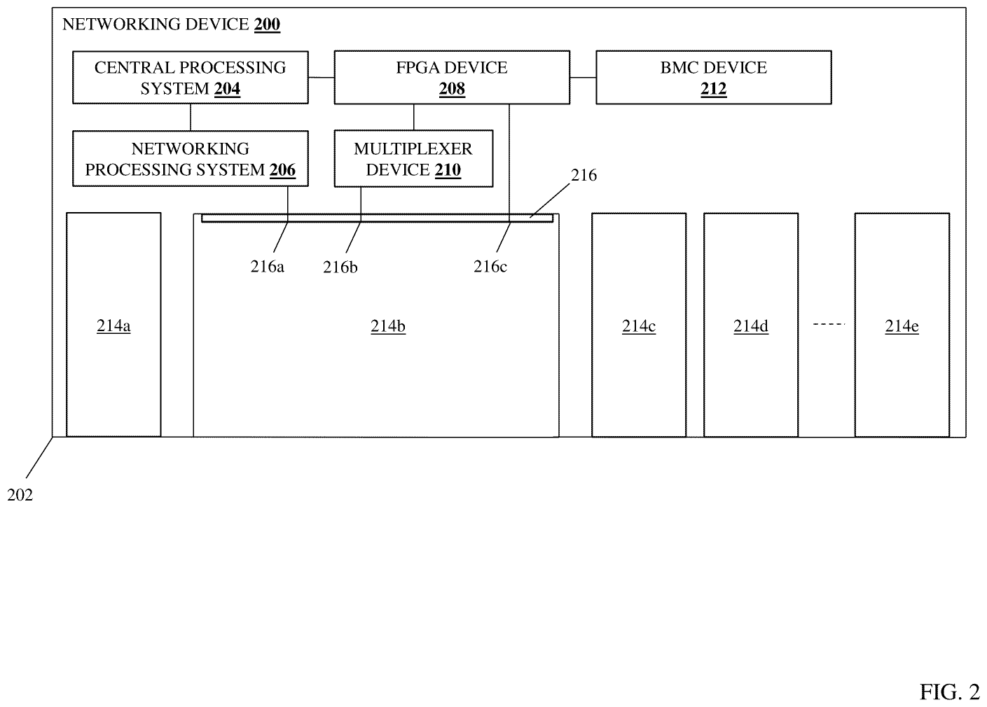

Referring now to FIG. 2, an embodiment of a networking device 200 is illustrated that may be included in the wireless transceiver information provisioning system of the present disclosure. In an embodiment, the networking device 200 may be provided by the IHS 100 discussed above with reference to FIG. 1 and/or may include some or all of the components of the IHS 100, and in specific examples may be provided by a switch device. However, while illustrated and described as being provided by a switch device, one of skill in the art in possession of the present disclosure will recognize that the functionality of the networking device 200 discussed below may be provided by server devices, storage systems, and/or other computing devices that are configured to operate similarly as the networking device 200 discussed below.

In the illustrated embodiment, the networking device 200 includes a chassis 202 that houses the components of the networking device 200, only some of which are illustrated and described below. As illustrated, the chassis 202 may house a central processing system 204 (e.g., which may be provided by the processor 102 discussed above with reference to FIG. 1 such as a Central Processing Unit (CPU)). In the specific examples provided below, the central processing system 204 may include a “host” CPU System on Chip (SoC) that is configured to provide a Networking Operating System (NOS) for the networking device 200 as described below, although other central processing systems are envisioned as falling within the scope of the present disclosure as well.

The chassis 202 may also house a networking processing system 206 (e.g., which may be similar to the processor 102 discussed above with reference to FIG. 1 such as a Networking Processing Unit (NPU)). In the specific examples provided below, the networking processing system 206 may include a Media Access Control/PHYsical layer (MAC/PHY) subsystem, although other networking processing systems are envisioned as falling within the scope of the present disclosure as well. The networking processing system 206 may be coupled to the central processing system 204 by a Peripheral Component Interconnect express (PCIe) connection and/or other couplings that would be apparent to one of skill in the art in possession of the present disclosure.

The chassis 202 may also house a Field Programmable Gate Array (FPGA) device 208 that may be coupled to the central processing system 204 by a PCIe connection and/or other couplings that would be apparent to one of skill in the art in possession of the present disclosure. The chassis 202 may also house a multiplexer device 210 that may include an Inter-Integrated Circuit (I2C) multiplexer, although other multiplexer devices are envisioned as falling within the scope of the present disclosure as well. The multiplexer device 210 may be coupled to the FPGA device 208 via an I2C coupling and/or other coupling known in the art, and one of skill in the art in possession of the present disclosure will recognize that the FGPA device 208 may use the multiplexer device 210 to provide control signals (e.g., the Serial DAta (SDA) signals, the Serial CLock (SCL) signals, and/or other control signals) to each of the transceiver ports/transceiver devices discussed below, as well as provide other signals (e.g., “ModPrsL” signals, “ModSel” signals, “LPMode” signals, “ResetL” signals, and/or other signals) that would be apparent to one of skill in the art in possession of the present disclosure.

The chassis 202 may also house a Baseboard Management Controller (BMC) device 212 that may be provided by the integrated DELL® Remote Access Controller (iDRAC) available in computing devices provided by DELL® Inc. of Round Rock, Texas, United States, and/or other BMC devices that would be apparent to one of skill in the art in possession of the present disclosure. The BMC device 212 may be coupled to the FPGA device 208 by a PCIe connection and/or other couplings that would be apparent to one of skill in the art in possession of the present disclosure.

The chassis 202 may also define a plurality of transceiver ports 214a, 214b, 214c, 214d, and up to 214e, each of which may be provided by a Quad Small Form-factor Pluggable (QSFP) port (e.g., a QSFP cage) and/or other transceiver ports known in the art. As will be appreciated by one of skill in the art in possession of the present disclosure. the transceiver port 214b is illustrated in FIG. 2 as larger than the other transceiver ports 214a and 214c-214e in order to provide clarity in the illustration and discussion of the components of the transceiver port 214b, transceiver devices connected thereto, and wireless transceiver information provisioning devices connected to those transceiver devices. As such, while not illustrated in the Figures or discussed below, one of skill in the art in possession of the present disclosure will appreciate how the transceiver ports 214a and 214c-214e may be configured and may operate similarly to the transceiver port 214b that is illustrated and described in detail below.

For example, as can be seen, a transceiver device connector subsystem 216 may be included the transceiver port 214b, and may be provided by a QSFP transceiver connector subsystem and/or other transceiver connector subsystems known in the art. In the examples discussed below, the networking processing system 206 may be coupled to a high speed data connection 216a on the transceiver device connector subsystem 216 using any high-speed data couplings that one of skill in the art in possession of the present disclosure will recognize allow for the transmission of high-speed data communications to a transceiver device. Furthermore, multiplexer device 210 may be coupled to a signal connection 216b on the transceiver device connector subsystem 216 via any signal couplings that one of skill in the art in possession of the present disclosure will recognize allow for the transmission of SDA signals, SCL signals, and/or other signals to a transceiver device. Further still, the FPGA device 208 may be coupled to a power/signal connection 216c on the transceiver device connector subsystem 216 via any power/signal couplings that one of skill in the art in possession of the present disclosure will recognize allow for the transmission of power (e.g., via a “Vcc” connection and a “GND” connection) and signals (e.g., via a “ModPrsL” signal connection, a “ModSel” signal connection, an “LPMode” signal connection, a ResetL” signal connection, etc.) to a transceiver device.

However, while a switch device including QSFP transceiver ports has been illustrated and described, one of skill in the art in possession of the present disclosure will recognize that any of a variety of computing devices may include any of a variety of transceiver ports (as well as other components and/or component configurations) for providing conventional networking/computing device functionality, as well as the wireless transceiver information provisioning functionality discussed below, while remaining within the scope of the present disclosure as well.

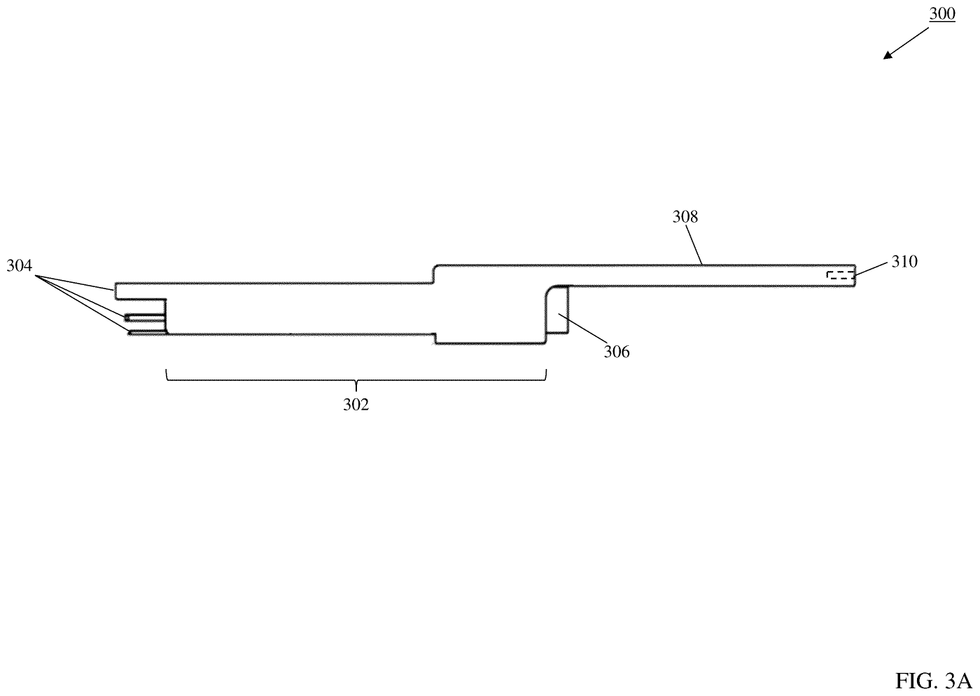

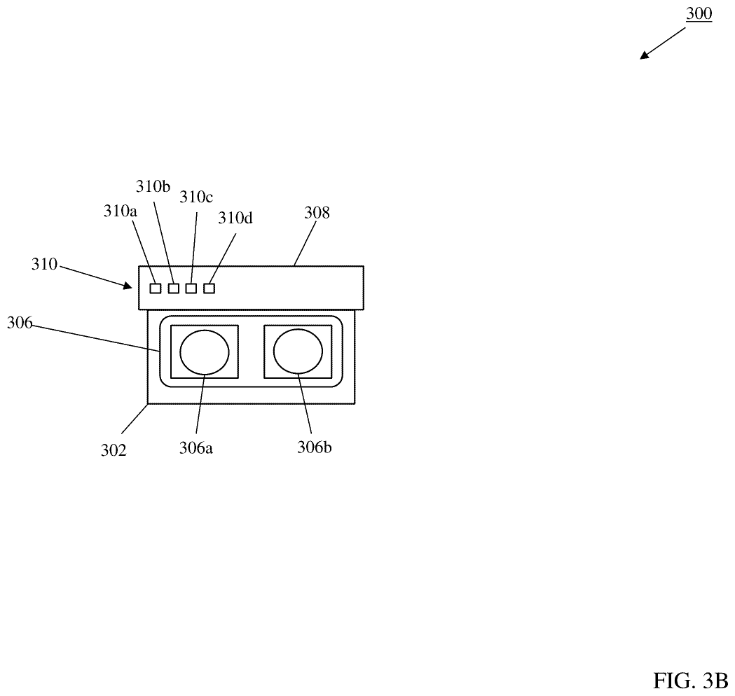

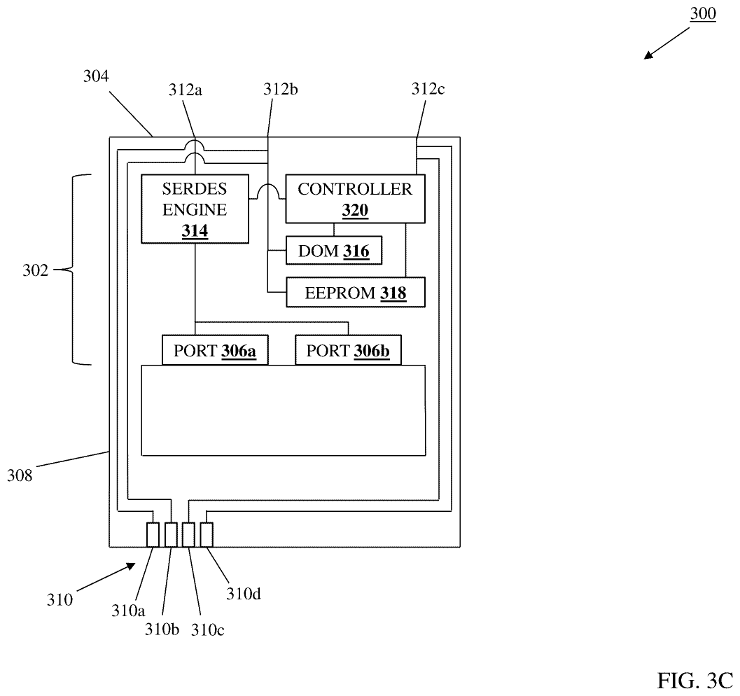

Referring now to FIGS. 3A, 3B, and 3C, an embodiment of a transceiver device 300 is illustrated that may be included in the wireless transceiver information provisioning system of the present disclosure. As discussed below, the transceiver device 300 may include features of a QSFP transceiver device, as well as the modifications discussed below that enable the wireless transceiver information provisioning functionality of the present disclosure, although the use of other types of transceiver devices according to the teachings of the present disclosure will fall within its scope as well. In the illustrated embodiment, the transceiver device includes a transceiver device chassis 302 that houses the components of the transceiver device 300, only some of which are illustrated and described below. A computing device connector 304 is included on an end of the transceiver device chassis 302, and may be provided by a QSFP connector and/or other computing device connectors that would be apparent to one of skill in the art in possession of the present disclosure. A port system 306 is included on an end of the transceiver device chassis 302 that is opposite the transceiver device chassis 302 from the transceiver device connector 304, and as illustrated in FIGS. 3B and 3C may include a pair of ports 306a and 306b.

A transceiver device handle 308 extends from the end of the transceiver device chassis 302 adjacent the port subsystem 306 and opposite the transceiver device chassis 302 from the transceiver device connector 304. As illustrated, the transceiver device handle 308 includes a wireless transceiver information provisioning device connector 310 on its distal end that is opposite its connection to the chassis 302, which in the specific examples illustrated and described below provides a female SCL signal connection 310a, a female SDA signal connection 310b, a female Vcc power connection 310c, and a female GND power connection 310d. However, while particular connections are illustrated as being provided by the wireless transceiver information provisioning device connector of the present disclosure, one of skill in the art in possession of the present disclosure will appreciate how other connectors/connections may be used to enable the functionality described below.

As can be seen in FIG. 3C, the computing device connector 304 includes a high speed data connection 312a. The transceiver device chassis 302 may house a SERializer/DESerializer (SERDES) processing system, as well as a SERDES memory system that includes instructions that, when executed by the SERDES processing system, cause the SERDES processing system to provide a SERDES engine 314 that is coupled to the high speed data connection 312a (e.g., via a coupling between the high speed data connection 312a and the SERDES processing system) and to each of the ports 306a and 306b (e.g., via a coupling between each of the ports 306a and 306b and the SERDES processing system), and that is configured to transmit high speed data signals between the high speed data connection 312a and the ports 306a and 306b.

The computing device connector 304 also includes a signal connection 312b, and as described below the female SCL signal connection 310a on the wireless transceiver information provisioning device connector 310 is configured to receive SCL signals from the signal connection 312b via a coupling that extends through the transceiver device handle 308, while the female SDA signal connection 310b on the wireless transceiver information provisioning device connector 310 is configured to receive SDA signals from the signal connection 312b via a coupling that extends through the transceiver device handle 308. The transceiver device chassis 302 may house a memory device that includes Digital Optical Management (DOM) 318 (e.g., at memory address 0x51) and an Electronically Erasable Programmable Read-Only Memory (EEPROM) 318 (e.g., at memory address 0x50), each of which is coupled to the signal connection 312b as well (i.e., via a coupling between the signal connection 312b and the memory device).

The computing device connector 304 also includes a power/signal connection 312c, and as described below the female Vcc power connection 310c on the wireless transceiver information provisioning device connector 310 is configured to receive Vcc power from the power/signal connection 312c via a coupling that extends through the transceiver device handle 308, while the female GND power connection 310d on the wireless transceiver information provisioning device connector 310 is configured to provide ground using the power/signal connection 312c via a coupling that extends through the transceiver device handle 308. The transceiver device chassis 302 may house a controller 320 (e.g., a microcontroller) that is coupled to the SERDES engine 314 (e.g., via a coupling between the controller 320 and the SERDES processing system), the signal connection 312c, and the memory device that provides the DOM 316 and the EEPROM 318, and that is configured to perform any of a variety of transceiver control operations that would be apparent to one of skill in the art in possession of the present disclosure.

As such, one of skill in the art in possession of the present disclosure will appreciate how the transceiver device 300 may include conventional components (i.e., the SERDES engine 314 connected to the ports 306a and 306b for use in performing high speed data transmission, as well as the controller 320 connected to the DOM 316, EEPROM 318, and the SERDES engine 314) that are housed in the transceiver device chassis 302 and connected to the computing device connector 304, while also providing for the rerouting of signals and power transmitted via connections provided by the computing device connector 304 (i.e., the SCL signals, SDA signals, Vcc power, and GND as described below) to the wireless transceiver information provisioning device connector 310 provided on the transceiver device handle 308 in order to enable the wireless transceiver information provisioning functionality described below. However, while a specific transceiver device 300 has been illustrated and described, one of skill in the art in possession of the present disclosure will appreciate how transceiver devices may include a variety of components and/or component configurations for providing conventional transceiver device functionality, as well as the wireless transceiver information provisioning functionality described below, while remaining within the scope of the present disclosure as well.

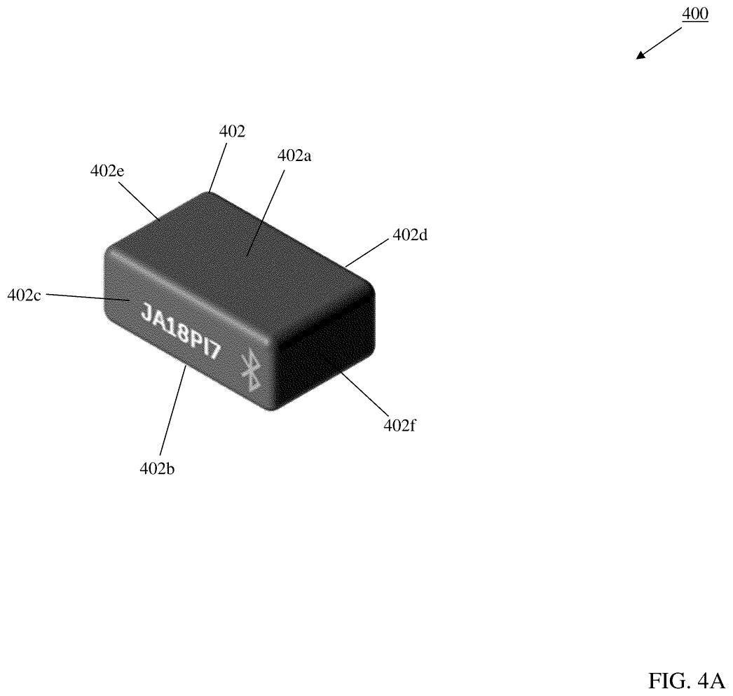

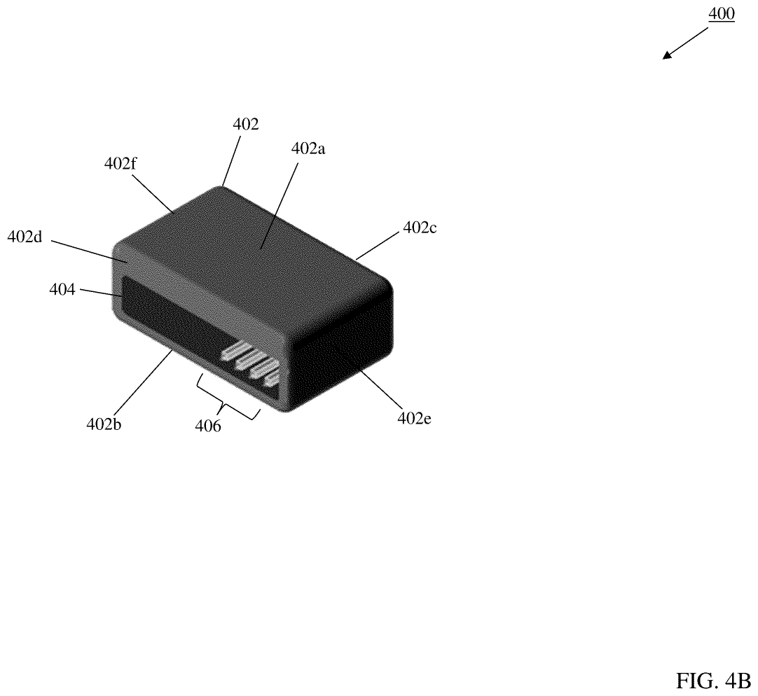

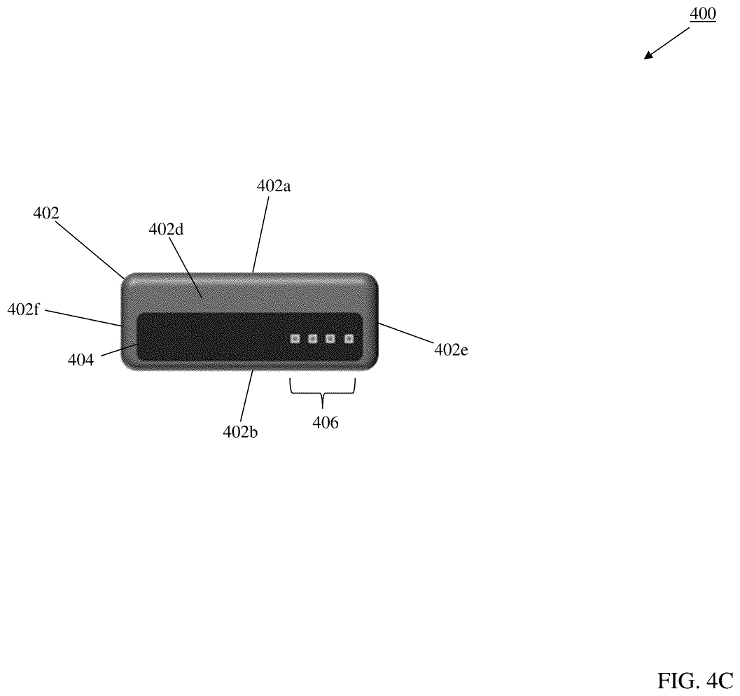

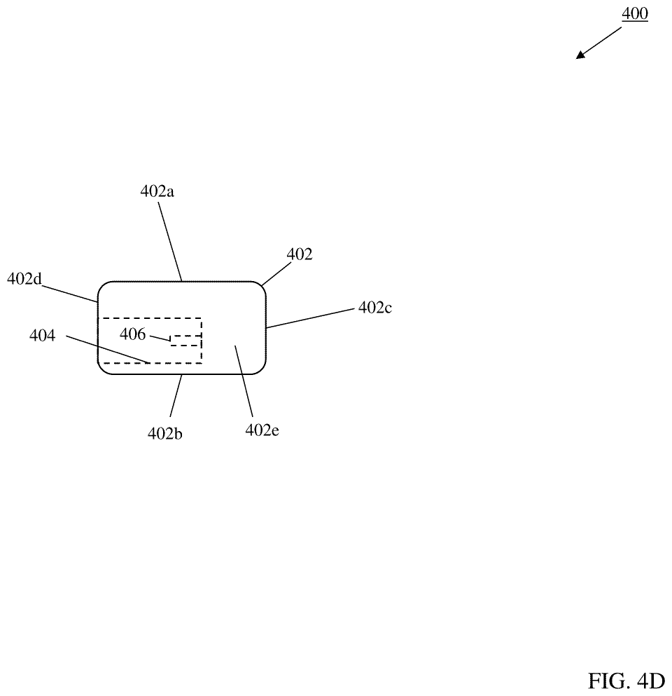

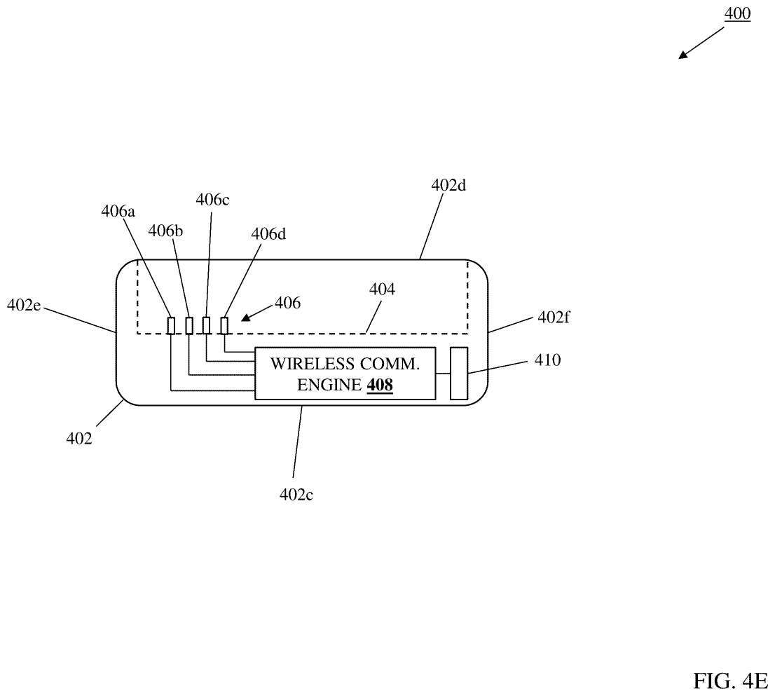

Referring now to FIGS. 4A, 4B, 4C, 4D, and 4E, an embodiment of a wireless transceiver information provisioning device 400 is illustrated that may be included in the wireless transceiver information provisioning system of the present disclosure. The wireless transceiver information provisioning device 400 includes a chassis 402 having a top surface 402a, a bottom surface 402b that is located opposite the chassis 402 from the top surface 402a, a front surface 402c that extends between the top surface 402a and the bottom surface 402b, a rear surface 402d that is located opposite the chassis 402 from the front surface 402c and that extends between the top surface 402a and the bottom surface 402b, and a pair of side surfaces 402e that are located opposite the chassis 402 from each other and that extend between the top surface 402a, the bottom surface 402b, the front surface 402c, and the rear surface 402d. As can be seen in FIG. 4A, in some embodiments a wireless transceiver information provisioning device identifier (e.g., the service tag “JA19PI7” in the examples illustrated and described below) and a wireless capability indicator (e.g., a Bluetooth indicator in the examples illustrated and described below) may be printed or otherwise provided on the front surface 402c of the chassis 400.

In the embodiments illustrated and described below, a transceiver device handle channel 404 is defined by the chassis 402 and extends into the chassis 402 from its rear surface 402d, and a transceiver device connector 406 is included in the transceiver handle channel 404. In the specific examples provided below, the transceiver device connector 406 provides a male SCL signal connection 406a, a male SDA signal connection 406b, a male Vcc power connection 406c, and a male GND power connection 406d. However, while particular location of the transceiver device connector 406 and particular connections provided by the transceiver device connector 406 are illustrated and described below, one of skill in the art in possession of the present disclosure will appreciate how other transceiver device connector locations and transceiver device connector connections may be used to enable the functionality described below.

With reference to FIG. 4E, the chassis 402 may house a wireless communication antenna, a wireless communication processing system, and a wireless communication memory system that includes instructions that, when executed by the wireless communication processing system, cause the wireless communication processing system to provide a wireless communication engine 408 that is configured to perform the functionality of the wireless communication engines and wireless transceiver information provisioning devices described below. In a specific example, the wireless communication engine 408 may be provided by a Bluetooth Low Energy (BLE) System on Chip (SoC) having an integrated antenna and that is configured to run a BLE software stack, although other processor/memory/antenna systems will fall within the scope of the present disclosure as well. The wireless communication engine 408 is coupled to the transceiver device connector 406, and thus configured to receive signals and power via the male SCL signal connection 406a, the male SDA signal connection 406b, the male Vcc power connection 406c, and the male GND power connection 406d (e.g., via a coupling between the wireless communication processing system and the male SCL signal connection 406a, the male SDA signal connection 406b, the male Vcc power connection 406c, and the male GND power connection 406d).

The chassis 402 may also house a memory device 410 that is coupled to the wireless communication engine 408 (e.g., via a coupling between the wireless communication processing system and the memory device 410), and that may include an EEPROM (e.g., at memory address 0x77) and/or other memory spaces that would be apparent to one of skill in the art in possession of the present disclosure. However, while a specific wireless transceiver information provisioning device 400 has been illustrated and described, one of skill in the art in possession of the present disclosure will appreciate how the wireless transceiver information provisioning device of the present disclosure may include a wide variety of components and/or component configurations while remaining within the scope of the present disclosure as well.

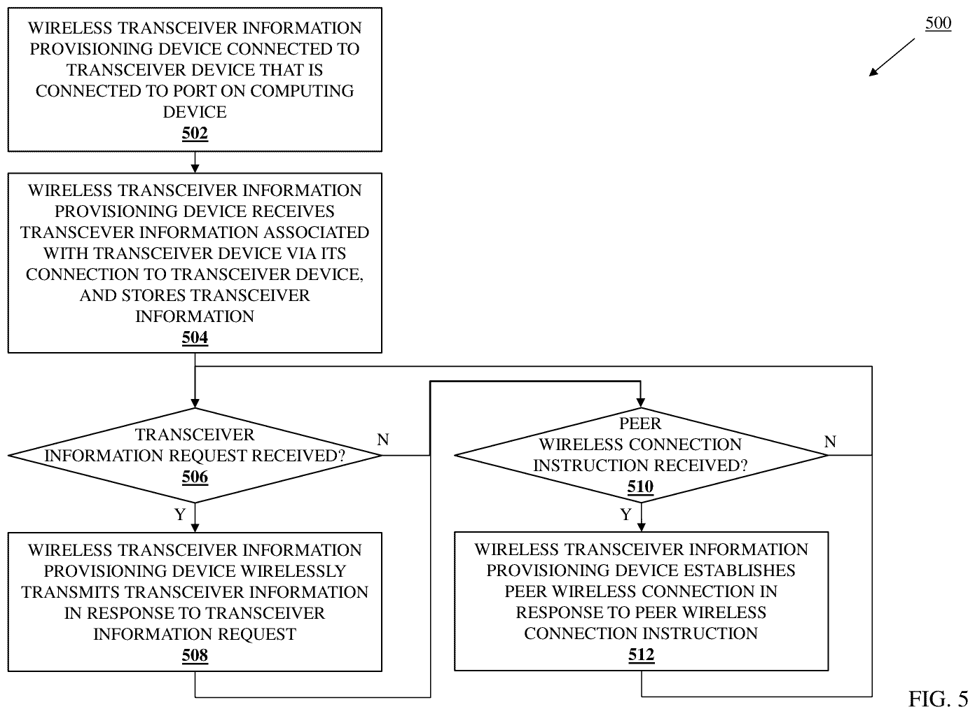

Referring now to FIG. 5, an embodiment of a method 500 for wirelessly providing information about a transceiver device is illustrated. As discussed below, the systems and methods of the present disclosure provide a wireless transceiver information provisioning device that may be connected to a transceiver that is connected to a port on a computing device, and may then retrieve and wirelessly transmit transceiver information associated with that transceiver device to a wireless device. For example, the wireless transceiver information provisioning device of the present disclosure may include a wireless transceiver information provisioning device chassis, a transceiver device connector on the wireless transceiver information provisioning device chassis that is connected to a wireless transceiver information provisioning device connector on a transceiver device that is connected to a port, and a wireless communication subsystem housed in the wireless transceiver information provisioning device chassis and coupled to the transceiver device connector. The wireless communication subsystem receives transceiver information associated with the transceiver device via the transceiver device connector, and stores the first transceiver information. When the wireless communication subsystem wirelessly subsequently receives a transceiver information request from a wireless device, it wirelessly transmit the transceiver information to the wireless device. As such, transceiver information associated with transceiver devices may be retrieved without the issues with conventional transceiver information retrieval systems discussed above.

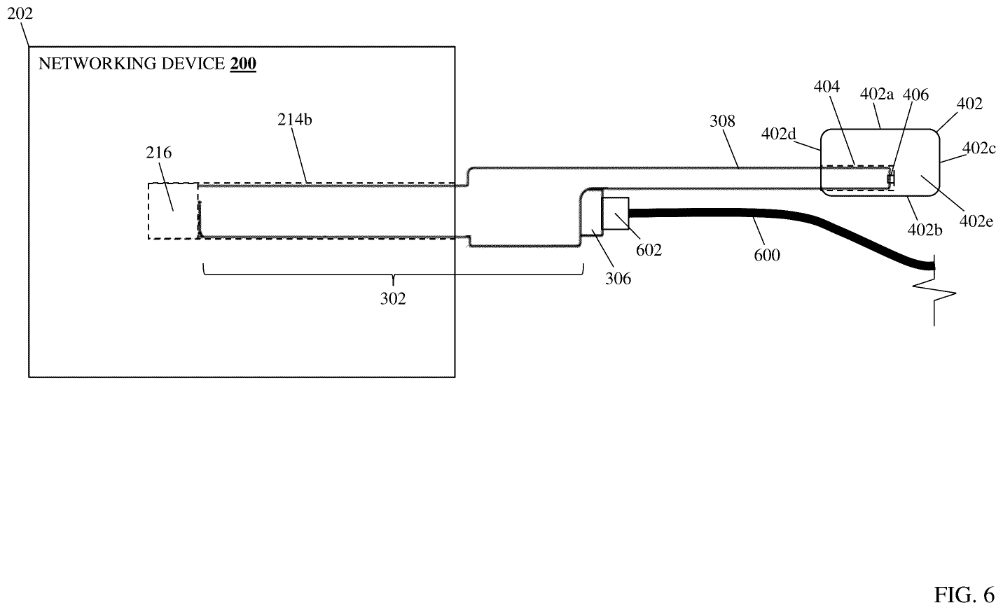

The method 500 begins at block 502 where a wireless transceiver information provisioning device is connected to a transceiver device that is connected to a port on a computing device. In an embodiment, at block 502, the transceiver device 300 discussed above with reference to FIG. 3 may be connected to the transceiver port 214b on the networking device 200 discussed above with reference to FIG. 2 by positioning the computing device connector 304 on the transceiver device 300 adjacent the transceiver port 214b and moving the transceiver device 300 into the transceiver port 214b such that the computing device connector 304 engages the transceiver device connector subsystem 216 in the transceiver port 214b, as illustrated in FIG. 6.

As also illustrated in FIG. 6, cable(s) 600 may be connected to the transceiver device 300 by connecting its cable connector(s) 602 to either of the ports 306a or 306b on the transceiver device 200, and as described in further detail below, another cable connector on the cable 600 (i.e., a cable connector opposite the cable 600 from the cable connector 602) may be connected to a transceiver port on another computing device similarly as described above.

Furthermore, at block 502, the wireless transceiver information provisioning device 400 may be connected to the transceiver device 300 by positioning the transceiver handle channel 404 on the wireless transceiver information provisioning device 400 adjacent the distal end of the transceiver device handle 308 on the transceiver device 300 such that the transceiver device connector 406 on the wireless transceiver information provisioning device 400 is aligned with the wireless transceiver information provisioning device connector 310 on the transceiver device handle 308, and then moving the wireless transceiver information provisioning device 400 towards the transceiver device 300 such that the transceiver device handle 308 enters the transceiver handle channel 404 and the transceiver device connector 406 engages the wireless transceiver information provisioning device connector 310, as illustrated in FIG. 6. As will be appreciated by one of skill in the art in possession of the present disclosure, the chassis 402 of the wireless transceiver information provisioning device 400 and its transceiver device handle channel 404 may be dimensioned and/or otherwise configured such that the cable 600 and cable connector 602 are not obstructed from connecting to and disconnecting from the ports 306a and 306b on the transceiver device 300 when the wireless transceiver information provisioning device 400 is connected thereto.

However, while block 502 is described above as including the connection of the transceiver device 300 to the transceiver port 214b on the networking device 200, followed by the connection of the wireless transceiver information provisioning device 400 to the transceiver device 300, one of skill in the art in possession of the present disclosure will appreciate how the wireless transceiver information provisioning device 400 may be connected to the transceiver device 300 prior to connection of the transceiver device 300 (with the wireless transceiver information provisioning device 400 connected thereto) to the transceiver port 214b on the networking device 200 while remaining within the scope of the present disclosure as well.

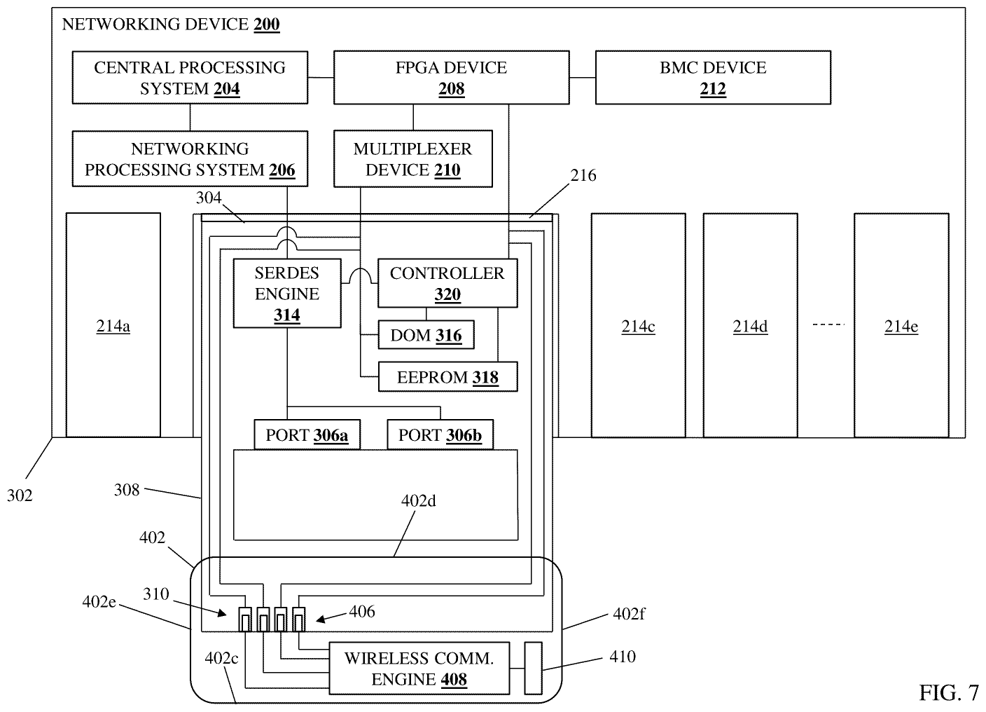

As can be seen in FIG. 7 (with reference to FIGS. 2 and 3C), with the transceiver device 300 connected to the transceiver port 214b on the networking device 200, the high speed data connection 312a, the signal connection 312b, and the signal/power connection 312c on the computing device connector 304 of the transceiver device 300 engage the high speed data connection 216a, the signal connection 216b, and the signal/power connection 216c on the transceiver device connector subsystem 216 of the networking device 200. Furthermore, as also can be seen in FIG. 7 (with reference to FIGS. 3C and 4E), with the wireless transceiver information provisioning device 400 connected to the transceiver device 300, the male SCL signal connection 406a, the male SDA signal connection 406b, the male Vcc power connection 406c, and the male GND power connection 406d on the transceiver device connector 406 of the wireless transceiver information provisioning device 400 engage the female SCL signal connection 310a, the female SDA signal connection 310b, the female Vcc power connection 310c, and the female GND power connection 310d on the wireless transceiver information provisioning device connector 310 of the transceiver device 300.

As discussed in further detail below, the coupling of the wireless communication engine 408 in the wireless transceiver information provisioning device 400 to the signal connection 216b and signal/power connection 216c on the transceiver device connector subsystem 216 of the networking device 200 (i.e., via the engagement of the transceiver device connector 406 on the wireless transceiver information provisioning device 400 and the wireless transceiver information provisioning device connector 310 on the transceiver device 300, as well as the connection of the computing device connector 304 on the transceiver device 300 to the transceiver device connector subsystem 216 of the networking device 200) allows the wireless communication engine 408 to receive power from the FPGA device 208, as well as SDA signals and SCL signals from the FPGA device 208 via the multiplexer device 210.

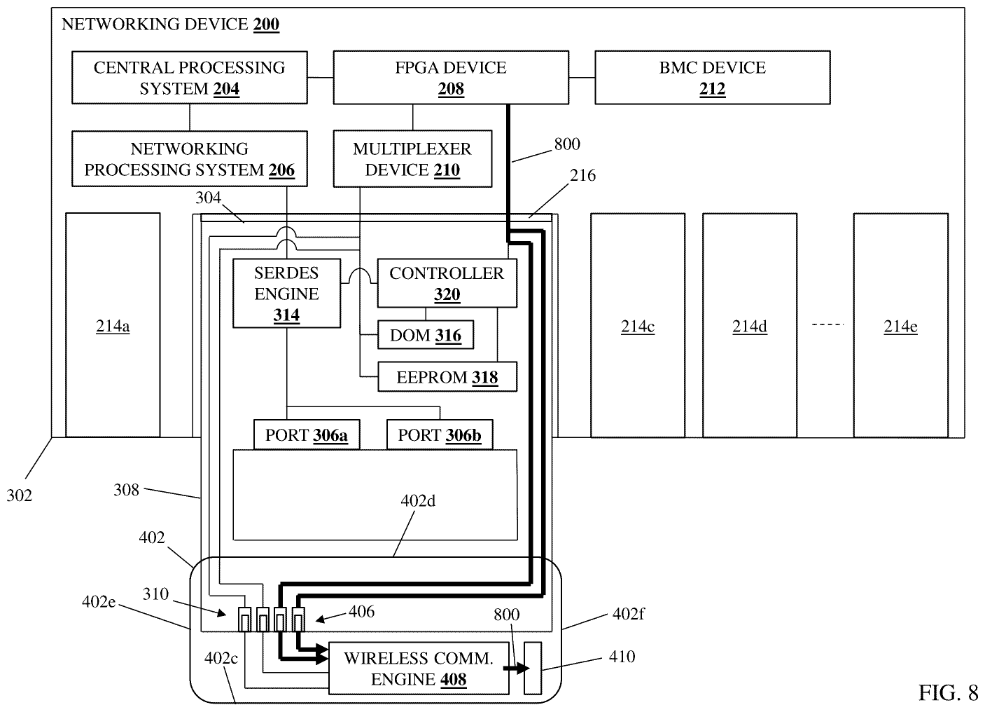

As such, and as can be seen in FIG. 8, following the connection of the wireless transceiver information provisioning device 400 to the transceiver device 300 and the transceiver device 300 to the networking device 200, the FPGA device 208 may perform power provisioning operations 800 that include providing power (from a power source included in or connected to the networking device 200, not illustrated) via the transceiver device 300 (e.g., via the power/signal connections 216c and 312c, the female Vcc power connection 406c and male Vccc power connection 310c, and the female GND power connection 406d and male GND power connection 310d) to the wireless communication engine 408 and other components of the wireless transceiver information provisioning device 400.

In a specific example, upon being powered, the wireless communication engine 408 and the memory device 410 in the wireless transceiver information provisioning device 400 may operate as I2C slaves on the I2C bus provided by the multiplexer device 210 along with the DOM 316 and the EEPROM 318 in the transceiver device 318. As described below, an operating system (e.g., the NOS discussed above provided by the central processing system 204, BMC firmware provided on the BMC device 212, etc.) may subsequently establish a communication channel (e.g., over I2C) with the wireless communication engine 408 (e.g., a BLE software stack running on the BLE SoC discussed above) to enable the communications described in further detail below, and one of skill in the art in possession of the present disclosure will appreciate how the transceiver device 300 may act as an I2C passthrough for such communications.

The method 500 then proceeds to block 504 where the wireless transceiver information provisioning device receives transceiver information associated with the transceiver device via its connection to the transceiver device, and stores the transceiver information. In an embodiment, at block 504 and following the powering of the wireless transceiver information provisioning device 400, the central processing system 204 (e.g., an agent running in the NOS provided by the central processing system 204 as discussed above) may poll transceiver buses (e.g., transceiver I2C buses) in the networking device 200 in order to detect the wireless communication engine 408 and the memory device 410/EEPROM in the wireless transceiver information provisioning device 400. However, while the operating system provided by the central processing system 204 is described as performing block 504, one of skill in the art in possession of the present disclosure will appreciate how the BMC device 212 may perform block 504 while remaining within the scope of the present disclosure as well.

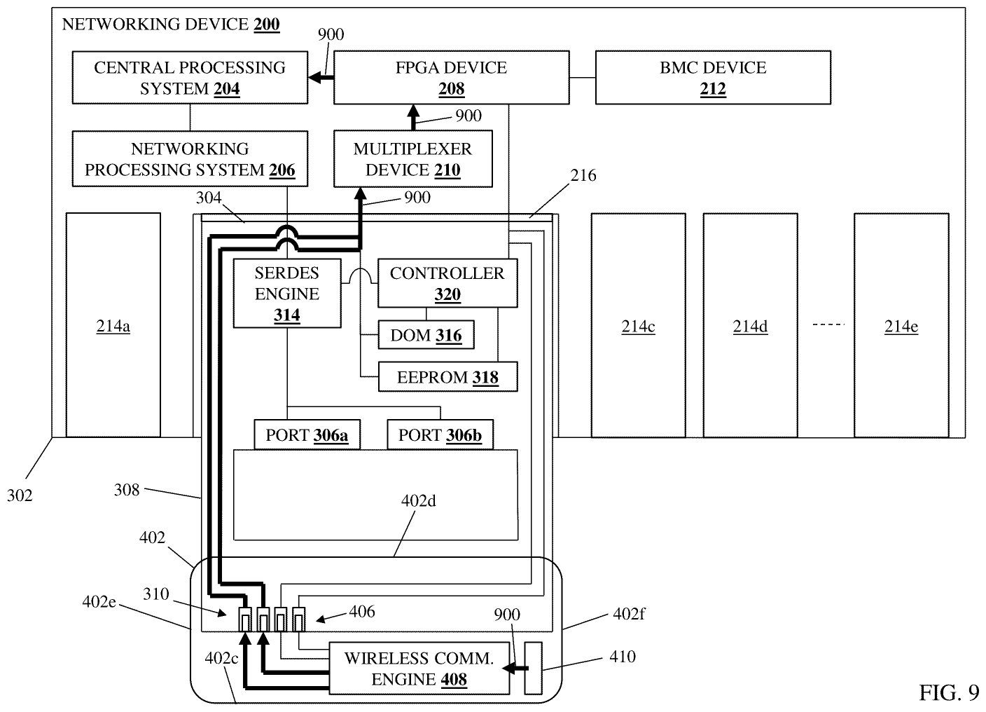

With reference to FIG. 9, upon detecting the memory device 410/EEPROM in the wireless transceiver information provisioning device 400, the central processing system 204 (e.g., an agent running in the NOS provided by the central processing system 204 as discussed above) may perform read operations 900 that include reading the memory device 410/EEPROM (e.g., via the transceiver device 300, the multiplexer device 210, and the FPGA device 208) to identify capability information for the wireless transceiver information provisioning device 400 that may include the capabilities of the wireless communication engine 408 (e.g., BLE capabilities), power requirements, and/or other capability information that would be apparent to one of skill in the art in possession of the present disclosure. In some embodiments, based on the power requirements of the wireless transceiver information provisioning device 400, the central processing system 204 (e.g., an agent running in the NOS provided by the central processing system 204 as discussed above) may turn off a low power mode of the wireless transceiver information provisioning device 400 and/or otherwise enable a normal power/high power mode of the wireless transceiver information provisioning device 400.

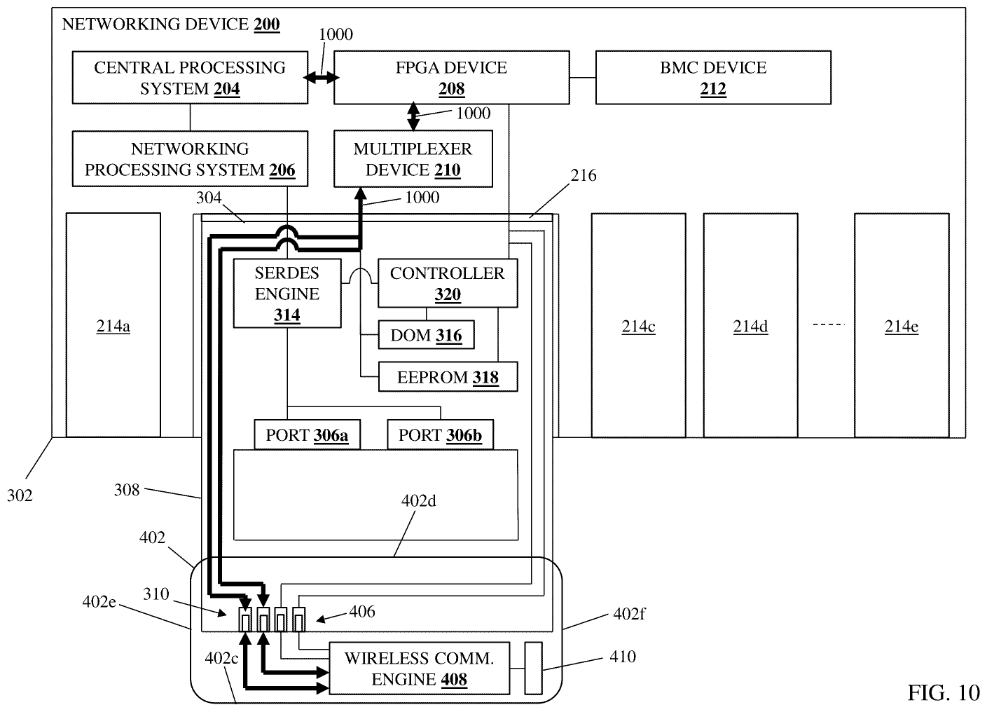

With reference to FIG. 10, the central processing system 204 (e.g., an agent running in the NOS provided by the central processing system 204 as discussed above) and the wireless communication engine 408 may then perform communication channel establishment operations 1000 (e.g., via the transceiver device 300, the multiplexer device 210, and the FPGA device 208) that include establishing a communication channel (e.g., over I2C) between the wireless communication engine 408 (e.g., the BLE software stack being run by the BLE SoC described above) and the central processing system 204 (e.g., the NOS provided by the central processing system 204 as discussed above) that is configured to allow the central processing system 204 (e.g., the NOS provided by the central processing system 204 as discussed above) to issue commands and process responses from the wireless communication engine 408.

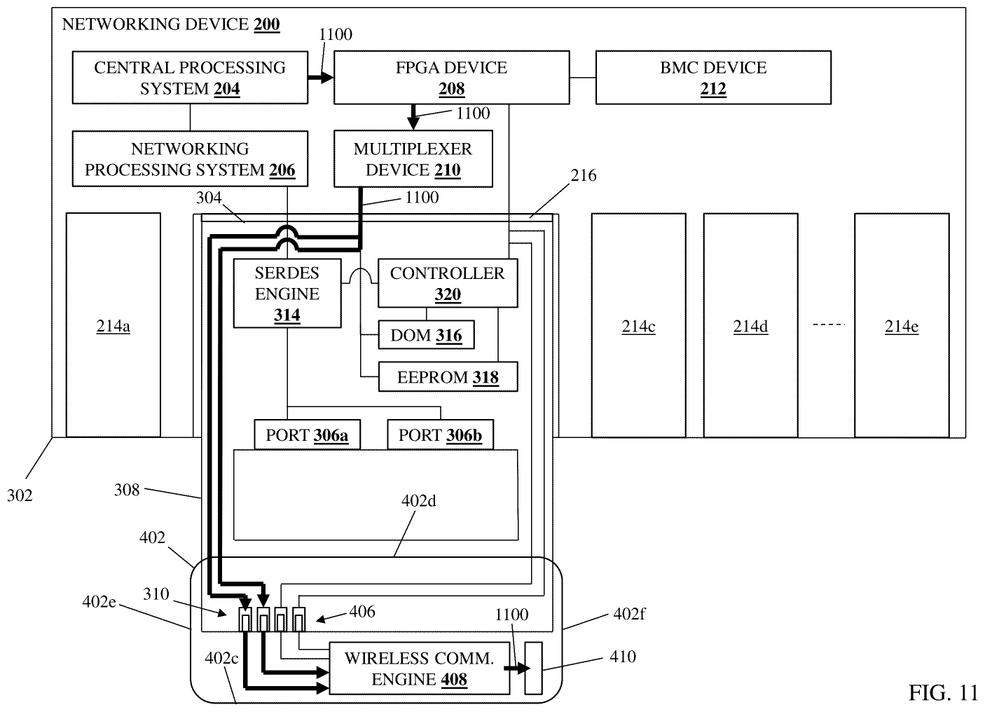

With reference to FIG. 11, the central processing system 204 (e.g., the NOS provided by the central processing system 204 as discussed above) may then perform transceiver information provisioning operations 1100 that include providing transceiver information associated with the transceiver device 300 to the wireless communication engine 408 (e.g., via the transceiver device 300, the multiplexer device 210, and the FPGA device 208) such that the wireless communication engine 408 stores that transceiver information in the memory device 410/EEPROM of the wireless transceiver information provisioning device 400. For example, the transceiver information provided in the memory device 410/EEPROM at block 504 may include networking device information for the networking device 200 such as a networking device identifier (e.g., a Stock Keeping Unit (SKU)) for the networking device 200, a hardware version of the networking device 200, a hostname of the networking device 200, an operating system version (e.g., a NOS version) of an operating system running on the networking device 200, and/or any other information about the networking device 200 to which the transceiver device 300 is connected that would be apparent to one of skill in the art in possession of the present disclosure.

Furthermore, the transceiver information provided in the memory device 410/EEPROM at block 504 may include transceiver port information for the transceiver port 214b on the networking device 200 such as a port identifier for the transceiver port 214b, a port speed configured for the transceiver port 214b, a port duplex setting configured for the transceiver port 214b, a port auto-negotiation setting configured for the transceiver port 214b, a port Forward Error Correction (FEC) setting (e.g., enabled/disabled) configured for the transceiver port 214b, a port breakout setting configured for the transceiver port 214b, a port power mode setting (e.g., low power mode, high power mode, etc.) configured for the transceiver port 214b, a port PAM4/NRX setting configured for the transceiver port 214b, port DOM information for the transceiver port 214b, any other port configuration information that would be apparent to one of skill in the art in possession of the present disclosure, as well as any information related to the NPU MAC/PHY layer status for the transceiver port 214b, and/or any other transceiver port information that would be apparent to one of skill in the art in possession of the present disclosure.

Furthermore, the transceiver information provided in the memory device 410/EEPROM at block 504 may include transceiver device information for the transceiver device 300 such as a transceiver type (e.g., an optical transceiver type, a Direct Attach Cable (DAC) transceiver type, an Active Electrical Cable (AEC) transceiver type, etc.) of the transceiver device 300, a transceiver identifier (e.g., a serial number) of the transceiver device 300, and/or any other transceiver device information that would be apparent to one of skill in the art in possession of the present disclosure. However, while a variety of specific transceiver information associated with a transceiver device has been described that includes information about the networking device to which it is connected, information about the transceiver port to which it is connected, and information about the transceiver device itself, one of skill in the art in possession of the present disclosure will appreciate how any transceiver information that may be used to provide the functionality discussed below may be provided in the memory device 410/EEPROM at block 504 while remaining within the scope of the present disclosure as well.

The method 500 then proceeds to decision block 506 where the method 500 proceeds depending on whether a transceiver information request is received. In an embodiment, at decision block 506 and following the transceiver information being provided in the wireless transceiver information provisioning device 400, the wireless communication engine 408 in the wireless transceiver information provisioning device 400 may monitor for transceiver information requests. As described below, a user of the wireless transceiver information provisioning system of the present disclosure may position a wireless device (e.g., a mobile phone) within wireless communication range of the wireless transceiver information provisioning device 400 and use that wireless device to provide the transceiver information request at decision block 506, although other techniques for providing the transceiver information request are envisioned as falling within the scope of the present disclosure as well.

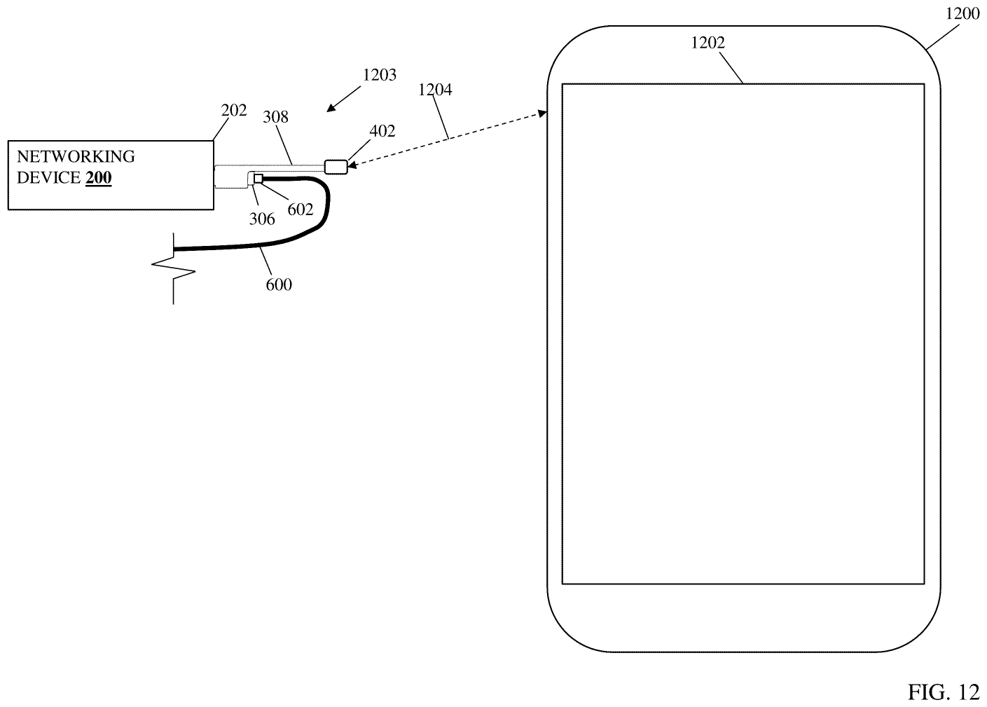

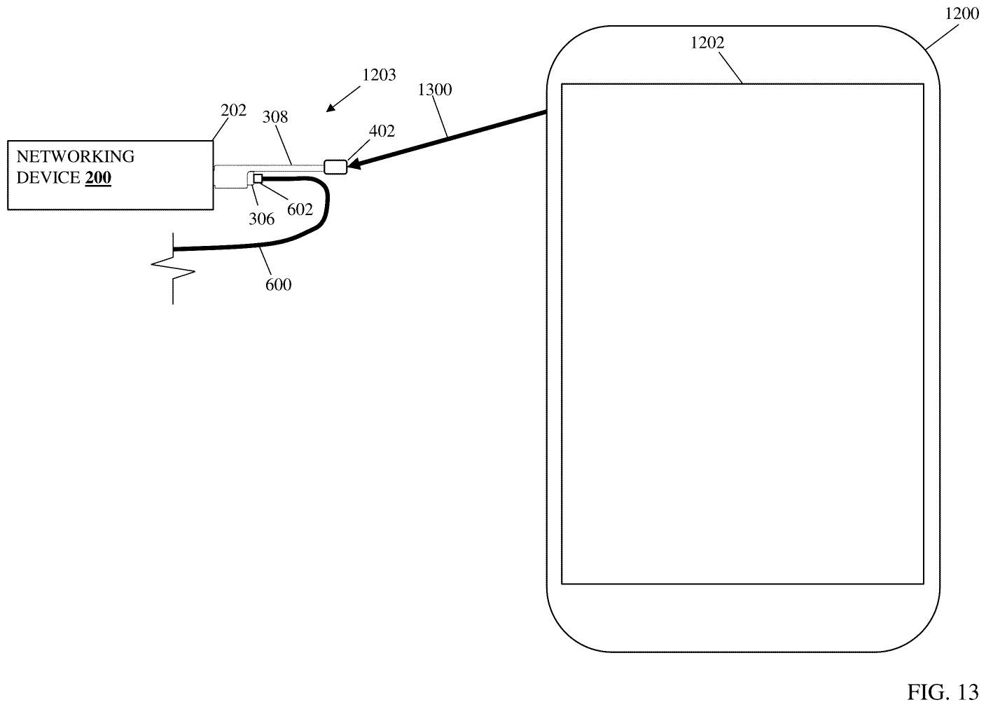

If, at decision block 506, a transceiver information request is received, the method 500 proceeds to block 508 where the wireless transceiver information provisioning device wirelessly transmits the transceiver information in response to the transceiver information request. With reference to FIG. 12, in an embodiment block 508, a user may position a wireless device 1200 (e.g., a mobile phone) including a display 1202 adjacent a wireless transceiver information provisioning system 1203 provided by the wireless transceiver information provisioning device 400 that is connected to the transceiver device 300 which is connected to the port 214b on the networking device 200 as described above. As illustrated, user may then use the wireless device 1200 to establish a wireless connection 1204 with the wireless communication engine 408 in the wireless transceiver information provisioning device 400 via any of a variety of wireless connection establishment techniques (e.g., BLE wires connection establishment techniques) that would be apparent to one of skill in the art in possession of the present disclosure. With reference to FIG. 13, the user may then use the wireless device 1200 to perform transceiver information request operations 1300 that include transmitting a transceiver information request via the wireless connection 1204 and to the wireless communication engine 408.

As will be appreciated by one of skill in the art in possession of the present disclosure, because of the nature of the transceiver information stored in the wireless transceiver information provisioning device 400 (i.e., the transceiver information is relatively “low value” information that need not be secured), the establishment of the wireless connection 1204 may be performed without authentication or other security procedures, thus allowing a user to simply connect the wireless transceiver information provisioning device 400 to the transceiver device 300 and then establish the wireless connection 1204 with the wireless device 1200 relatively quickly and without the need to provide authentication information or otherwise authenticate with the wireless transceiver information provisioning device 400.

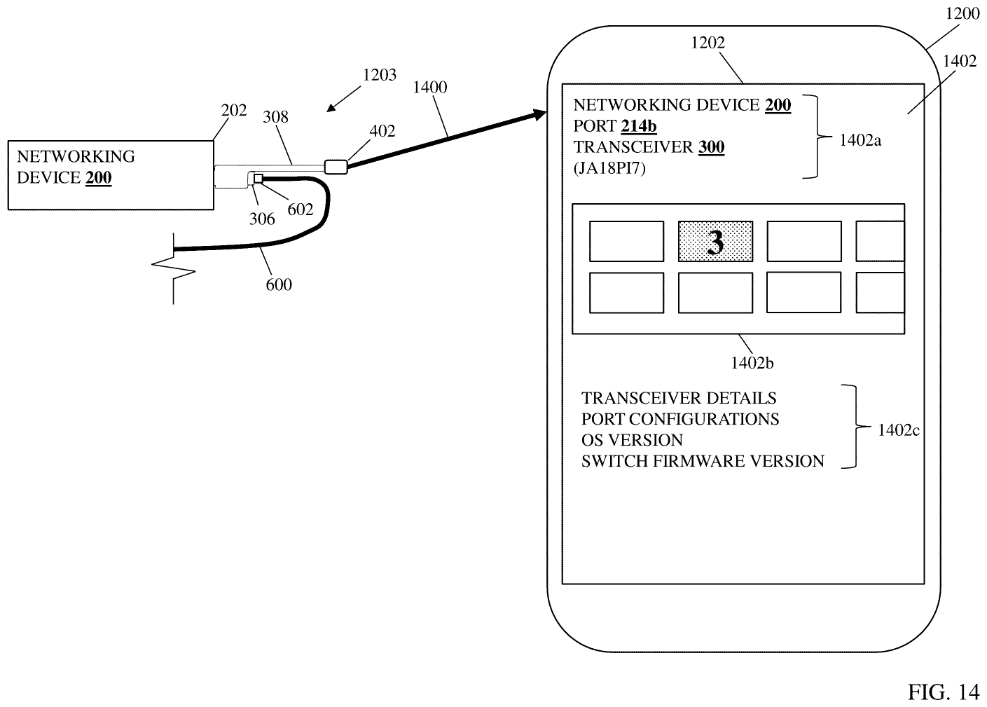

With reference to FIG. 14, in an embodiment of block 508 and in response to receiving the transceiver information request, the wireless communication engine 408 in the wireless transceiver information provisioning device 400 may perform transceiver information provisioning operations 1400 that include retrieving the transceiver information stored in its memory device 410/EEPROM, and transmitting that transceiver information via the wireless connection 1204 and to the wireless device 1200. As can be seen in FIG. 14, the wireless device 1200 may then use that transceiver information to provide a transceiver information screen 1402. In the illustrated embodiment, the transceiver information screen 1402 includes a hardware identification section 1402a that identifies the networking device 200 (e.g., a service tag for the networking device 200) to which the transceiver device 300 is connected, the port 214b (e.g., a port address of the port 214b on the networking device 200) to which the transceiver device 300 is connected, the transceiver device 300 (e.g., a serial number of the transceiver device 300), and the wireless transceiver information provisioning device 400 (e.g., via its identifier “JA18PI7” in the illustrated example).

Furthermore, in the illustrated embodiment, the transceiver information screen 1402 also includes a graphical identification section 1402b that provides a graphical representation of the networking device 200 and the port 214b on the networking device 200 to which the transceiver device 300 is connected (e.g., port “3” in the illustrated example). Further still, in the illustrated embodiment, the transceiver information screen 1402 also includes a details section 1402c that identifies any of a variety of details about the transceiver device 300, configurations for the port 214b, a version of the operating system provided by the central processing system 204 in the networking device 200, and a version of the firmware including the networking device 200. However, while a specific transceiver information screen 1402 has been illustrated and described, one of skill in the art in possession of the present disclosure will appreciate how any of a variety of transceiver information provided to the wireless device 1200 may be displayed in any of a variety of manners that will fall within the scope of the present disclosure as well.

As such, one of skill in the art in possession of the present disclosure will appreciate how embodiments of the present disclosure may include a user connecting the wireless transceiver information provisioning device 400 to the transceiver device 300 that is connected to the port 214b on the networking device 200 to retrieve any of the transceiver information described above and provide it for display on the wireless device 1200 for any of a variety of a reasons.

If, at decision block 506, no transceiver information request is received, or following block 508, the method 500 proceeds to decision block 510 where the method 500 proceeds depending on whether a peer wireless connection instruction is received. In an embodiment, at decision block 510, the wireless communication engine 408 in the wireless transceiver information provisioning device 400 may monitor for peer wireless connection instructions. As described below, a user of the wireless transceiver information provisioning system of the present disclosure may position a wireless device (e.g., a mobile phone) within wireless communication range of the wireless transceiver information provisioning devices connected to transceiver devices that are being used to connect respective networking devices, and use that wireless device to provide the peer wireless connection instruction at decision block 510, although other techniques for providing the peer wireless connection instruction are envisioned as falling within the scope of the present disclosure as well. If, at decision block 510, no peer wireless connection instruction is received, the method 500 returns to decision block 506. As such, the wireless transceiver information provisioning device 400 may monitor for transceiver information requests and/or peer wireless connection instructions until they are received.

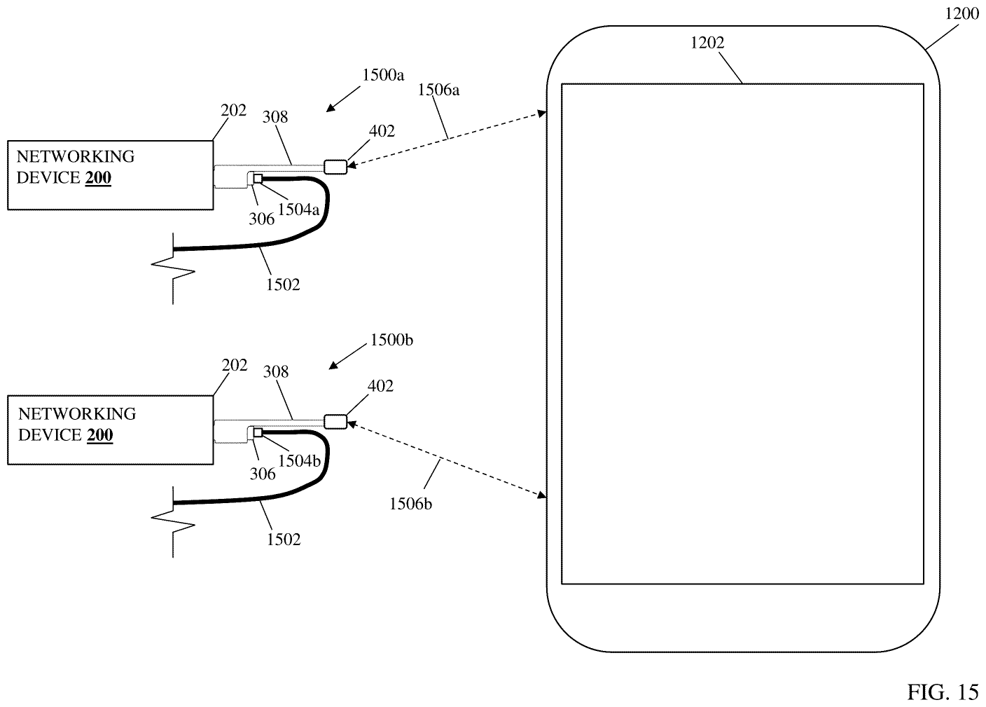

If, at decision block 510, a peer wireless connection instruction is received, the method 500 proceeds to block 512 where the wireless transceiver information provisioning device establishes a peer wireless connection in response to the peer wireless connection instruction. Similarly as described above and with reference to FIG. 15, at decision block 506 a user may position the wireless device 1200 (e.g., a mobile phone) including the display 1202 adjacent a wireless transceiver information provisioning system 1500a and wireless transceiver information provisioning system 1500b that are provided similarly as described above to connect a pair of the networking devices 200 with a cable 1502 that includes a cable connector 1504a connected to a transceiver device 300 in the wireless transceiver information provisioning system 1500a, and a cable connector 1504b connected to a transceiver device 300 in the wireless transceiver information provisioning system 1500b.

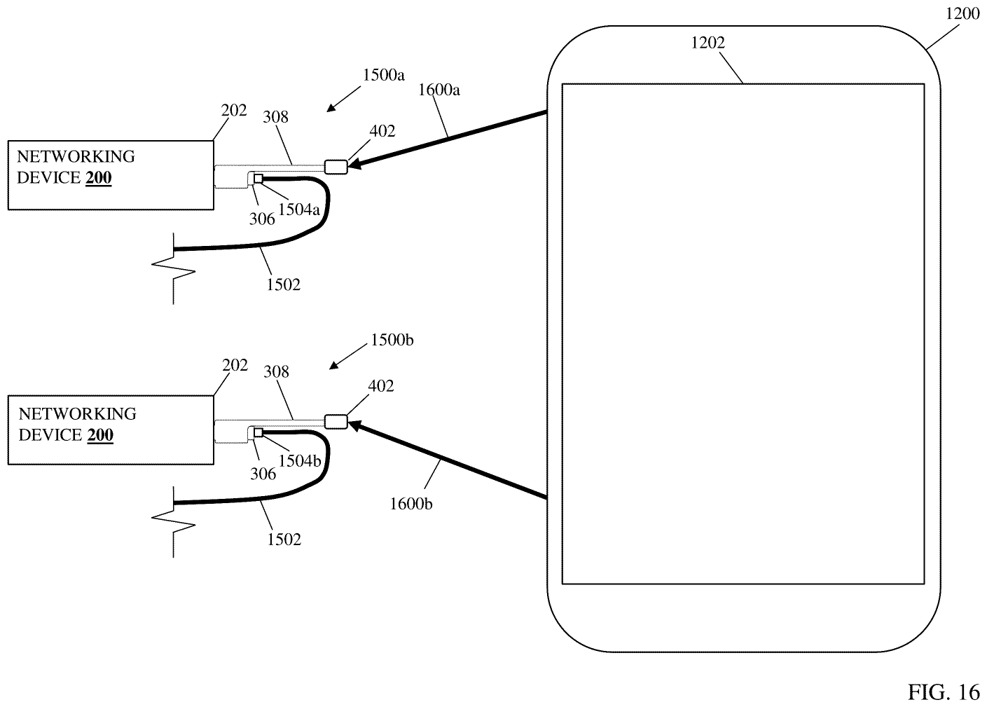

Similarly as described above, at decision block 506 the user may then use the wireless device 1200 to establish a wireless connection 1506a with the wireless communication engine 408 in the wireless transceiver information provisioning device 400 included in the wireless transceiver information provisioning system 1500a, and establish a wireless connection 1506b with the wireless communication engine 408 in the wireless transceiver information provisioning device 400 included in the wireless transceiver information provisioning system 1500b. Similarly as described above and with reference to FIG. 16, at decision block 506 the user may then use the wireless device 1200 to perform transceiver information request operations 1600a that include transmitting a transceiver information request via the wireless connection 1506a and to the wireless communication engine 408 in the wireless transceiver information provisioning device 400 included in the wireless transceiver information provisioning system 1500a, and perform transceiver information request operations 1600b that include transmitting a transceiver information request via the wireless connection 1506b and to the wireless communication engine 408 in the wireless transceiver information provisioning device 400 included in the wireless transceiver information provisioning system 1500b.

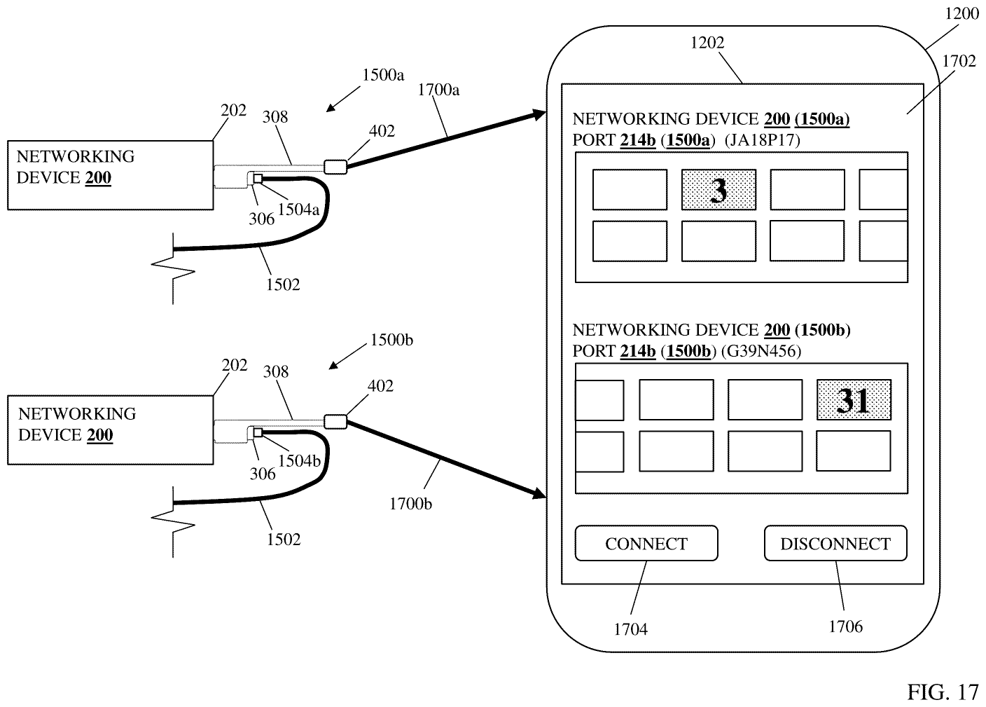

Similarly as described above and with reference to FIG. 17, in response to receiving the transceiver information request, the wireless communication engine 408 in the wireless transceiver information provisioning device 400 included in the wireless transceiver information provisioning system 1500a may perform transceiver information provisioning operations 1700a that include retrieving the transceiver information stored in its memory device 410/EEPROM, and transmitting that transceiver information via the wireless connection 1506a and to the wireless device 1200, and the wireless communication engine 408 in the wireless transceiver information provisioning device 400 included in the wireless transceiver information provisioning system 1500b may perform transceiver information provisioning operations 1700b that include retrieving the transceiver information stored in its memory device 410/EEPROM, and transmitting that transceiver information via the wireless connection 1506b and to the wireless device 1200.

As can be seen in FIG. 17, the wireless device 1200 may then use the transceiver information received from the wireless transceiver information provisioning systems 1500a and 1500b to provide a transceiver information screen 1702. In the illustrated embodiment, the transceiver information screen 1702 includes a first wireless transceiver information provisioning system section that identifies the networking device 200 (e.g., a service tag for the networking device 200) in the wireless transceiver information provisioning system 1500a, the port 214b (e.g., a port address for the port 214b on the networking device 200) in the wireless transceiver information provisioning system 1500a, and the wireless transceiver information provisioning device 400 (e.g., via its identifier “JA18PI7” in the illustrated example) in the wireless transceiver information provisioning system 1500a, as well as including a graphical representation of the port 214b in the networking device 200 that is providing the wireless transceiver information provisioning system 1500a (i.e., port “3” in the illustrated example).

In the illustrated embodiment, the transceiver information screen 1702 also includes a second wireless transceiver information provisioning system section that identifies the networking device 200 (e.g., a service tag for the networking device 200) in the wireless transceiver information provisioning system 1500b, the port 214b (e.g., a port address for the port 214b on the networking device 200) in the wireless transceiver information provisioning system 1500b, and the wireless transceiver information provisioning device 400 (e.g., via its identifier “G39N456” in the illustrated example) in the wireless transceiver information provisioning system 1500b, as well as including a graphical representation of the port 214b in the networking device 200 that is providing the wireless transceiver information provisioning system 1500b (i.e., port “31” in the illustrated example). However, while the transceiver information screen 1702 is illustrated and providing less information for each wireless transceiver information provisioning system 1500a and 1500b than the transceiver information screen 1402 discussed above with reference to FIG. 14, one of skill in the art in possession of the present disclosure will appreciate that the transceiver information screen 1702 may provide any of the transceiver information described above (e.g., with reference to the transceiver information screen 1402 of FIG. 14) for each wireless transceiver information provisioning system 1500a and 1500b while remaining within the scope of the present disclosure as well.

In the illustrated embodiment, the transceiver information screen 1702 also includes a peer wireless connection establishment instruction provisioning element 1704 (e.g., a “CONNECT” Graphical User Interface (GUI) button) that may be used to provide the peer wireless connection instruction at decision block 510, and a peer wireless disconnection instruction provisioning element 1704 (e.g., a “DISCONNECT” GUI button) that, while not described in detail below, may be used to disconnect any peer wireless connection established at block 512.

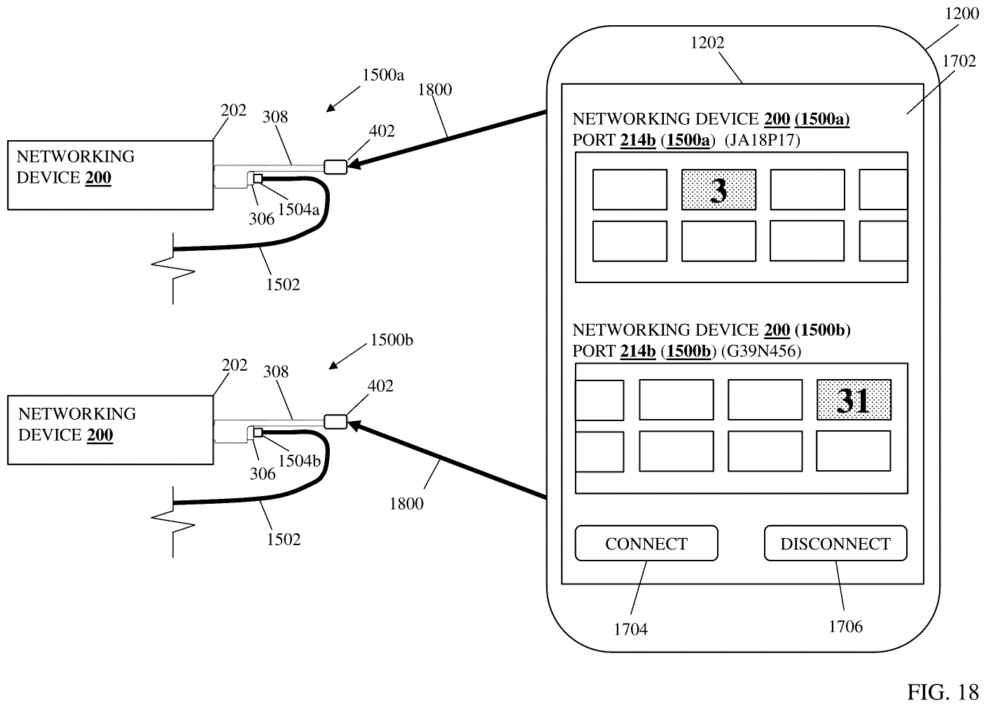

With reference to FIG. 18, in an embodiment of block 510, the user may then identify the wireless transceiver information provisioning systems 1500a and 1500b (e.g., by selecting the graphical representations of the ports 214b in the networking devices 200 that are providing the wireless transceiver information provisioning systems 1500a and 1500b, i.e., ports “3” and “31” on the transceiver information screen 1702 in the illustrated examples), and then selecting the peer wireless connection establishment instruction provisioning element 1704 (e.g., the “CONNECT” GUI button) in order to cause the wireless device 1200 to perform peer wireless connection instruction provisioning operations 1800 that include transmitting a peer wireless connection instruction to the wireless transceiver information provisioning device 400 in each of the wireless transceiver information provisioning systems 1500a and 1500b.

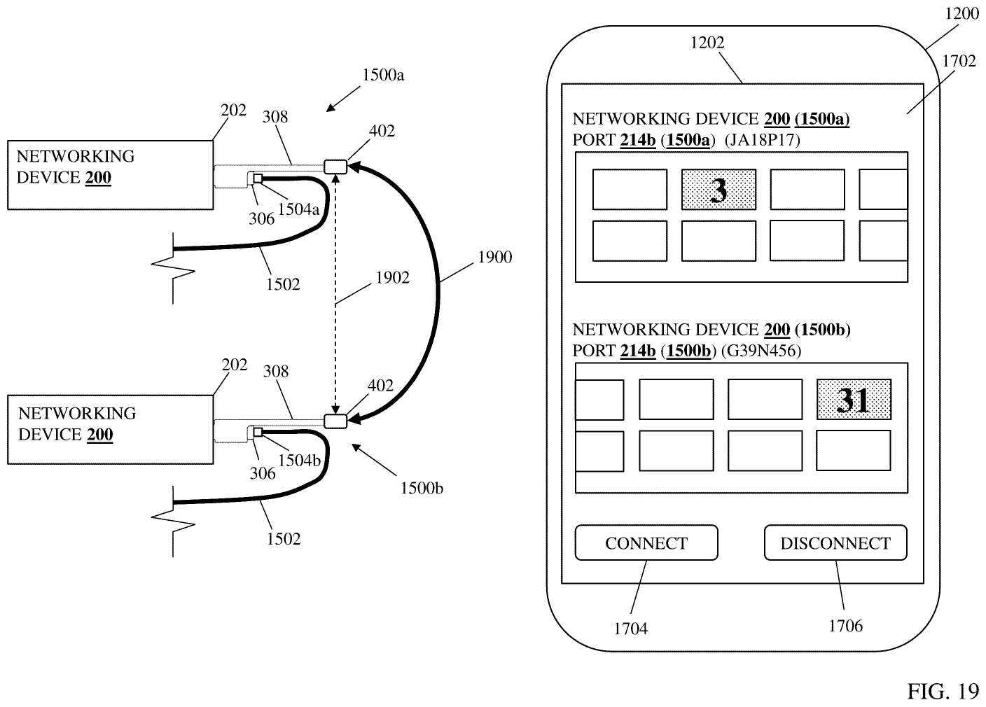

With reference to FIG. 19, in response to receiving the peer wireless connection instruction, the wireless communication engines 408 in the wireless transceiver information provisioning devices 400 included in the wireless transceiver information provisioning systems 1500a and 1500b may perform peer wireless connection establishment operations 1900 that provide a peer wireless connection 1902 between the wireless communication engines 408 in the wireless transceiver information provisioning devices 400 included in the wireless transceiver information provisioning systems 1500a and 1500b using any of a variety of peer wireless connection establishment techniques (e.g., BLE peer wireless connection establishment techniques) that would be apparent to one of skill in the art in possession of the present disclosure. For example, the wireless communication engines 408 in the wireless transceiver information provisioning devices 400 included in the wireless transceiver information provisioning systems 1500a and 1500b may perform primary wireless transceiver information provisioning device election operations to elect one of those wireless communication engines 408/wireless transceiver information provisioning devices 400 as a “primary” controller of the peer wireless connection 1902 (e.g., the wireless transceiver information provisioning device with the “lowest” Media Access Control (MAC) address may be elected as the “primary” controller of the peer wireless connection 1902).

As discussed below, the peer wireless connection 1902 may then subsequently operate as an out-of-band communication channel for the operating systems provided by the central processing systems 204 (or for the BMC devices 212) in the networking devices 200 in the wireless transceiver information provisioning systems 1500a and 1500b. In some embodiments, the wireless communication engines 408 in the wireless transceiver information provisioning devices 400 included in the wireless transceiver information provisioning systems 1500a and 1500b may confirm the establishment of the peer wireless connection 1902 to the wireless device 1200 (i.e., via the wireless connections 1506a and 1506b, and that confirmed peer wireless connection may be displayed on the transceiver information screen 1702 (e.g., by providing the graphical representation of the ports “3” and “31” on the transceiver information screen 1702 in a green color). The method then returns to decision block 506.

As will be appreciated by one of skill in the art in possession of the present disclosure, the peer wireless connection 1902 between the wireless communication engines 408 in the wireless transceiver information provisioning devices 400 included in the wireless transceiver information provisioning systems 1500a and 1500b may then be used for any of a variety of reasons.

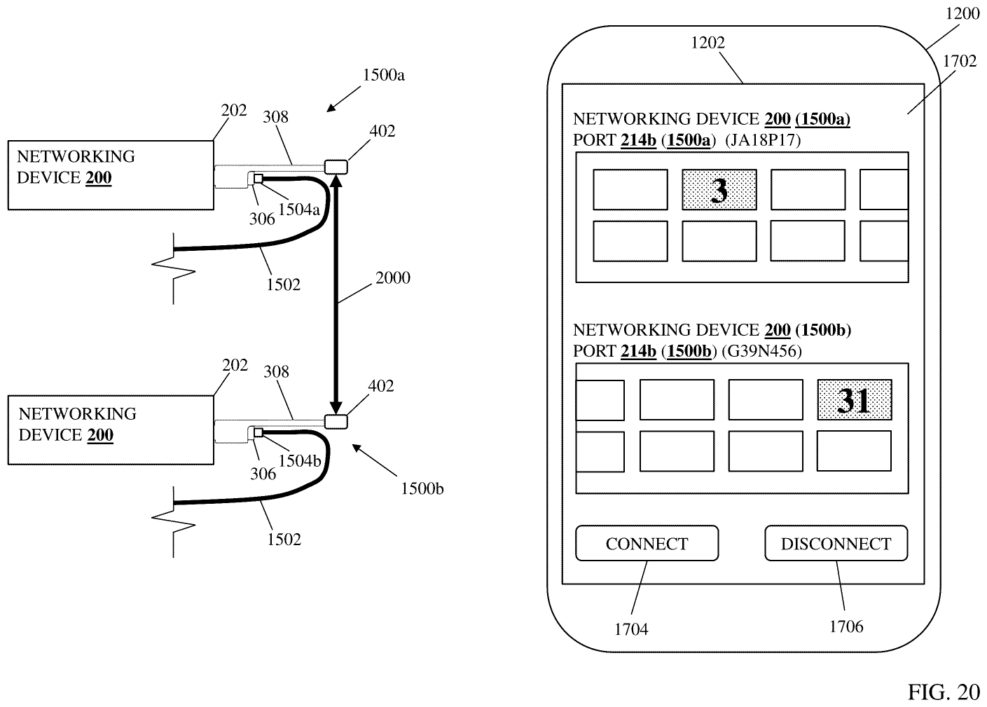

To provide a specific example, a user wishing to troubleshoot an unavailable link between the ports 214b on the networking devices 200 in the wireless transceiver information provisioning systems 1500a and 1500b (i.e., a link that should be available via the cable 1502) may establish the peer wireless connection 1902 between the wireless communication engines 408 in the wireless transceiver information provisioning devices 400 included in the wireless transceiver information provisioning systems 1500a and 1500b as described above in order to automate the troubleshooting of that unavailable link. For example, with reference to FIG. 20 and following the establishment of the peer wireless connection 1902, the wireless communication engines 408 in the wireless transceiver information provisioning devices 400 in the wireless transceiver information provisioning systems 1500a and 1500b may perform transceiver information exchange operations 2000 that include exchanging their stored transceiver information via the peer wireless connection 1902 such that each stores its transceiver information and the the transceiver information of the other in its memory device 410/EEPROM.

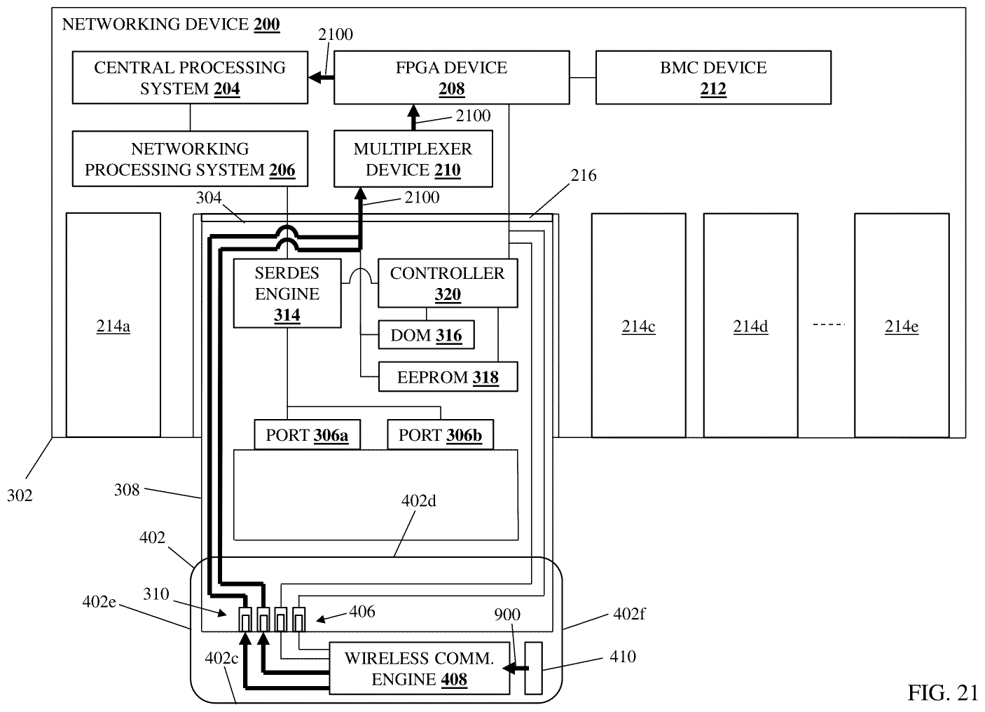

With reference to FIG. 21, the operating system provided by the central processing system 204 (or the BMC device 212) in the networking device 200 in one or both of the wireless transceiver information provisioning systems 1500a and 1500b may then perform transceiver information retrieval operations 2100 (e.g., via the transceiver device 300, the multiplexer device 210, and the FPGA device 208) that include accessing the wireless communication engine 408 in the wireless transceiver information provisioning device 400 in its wireless transceiver information provisioning system 1500a or 1500b, and retrieve the transceiver information from both of the wireless transceiver information provisioning devices 400 in the wireless transceiver information provisioning systems 1500a and 1500b.

In some embodiments, the operating system provided by the central processing system 204 (or the BMC device 212) in the networking device 200 in the wireless transceiver information provisioning system 1500a may then perform link troubleshooting operations that may include comparing the state of its transceiver port 214b with the transceiver information retrieved for the wireless transceiver information provisioning system 1500b, performing link recovery operations such as adjusting the port configuration of its transceiver port 214b, adjusting NPU MAC/PHY parameters associated with its transceiver port 214b, and/or using other link recovery techniques (e.g., changing the port speed, changing the port duplex settings, changing port Auto Negotiation (AN) settings, changing port FEC settings, changing port breakout settings, etc.) that one of skill in the art in possession of the present disclosure would recognize as causing the link provided by the cable 1900 to become available.

Furthermore, in some embodiments, the operating system provided by the central processing system 204 (or the BMC device 212) in the networking device 200 in the wireless transceiver information provisioning system 1500a may use the transceiver information from both of the wireless transceiver information provisioning devices 400 in the wireless transceiver information provisioning systems 1500a and 1500b to perform diagnostics, NPU-assisted data traffic tests, and/or other link testing operations known in the art, and may also validate any results with the operating system provided by the central processing system 204 (or the BMC device 212) in the networking device 200 in the wireless transceiver information provisioning system 1500b (which may perform those same link testing operations on its end).

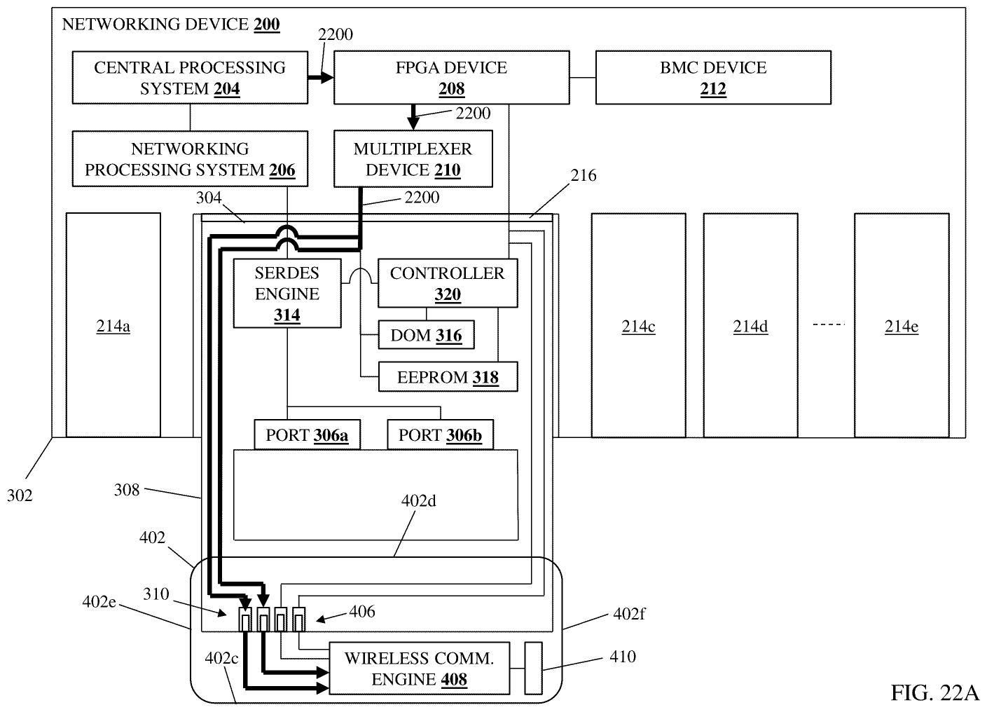

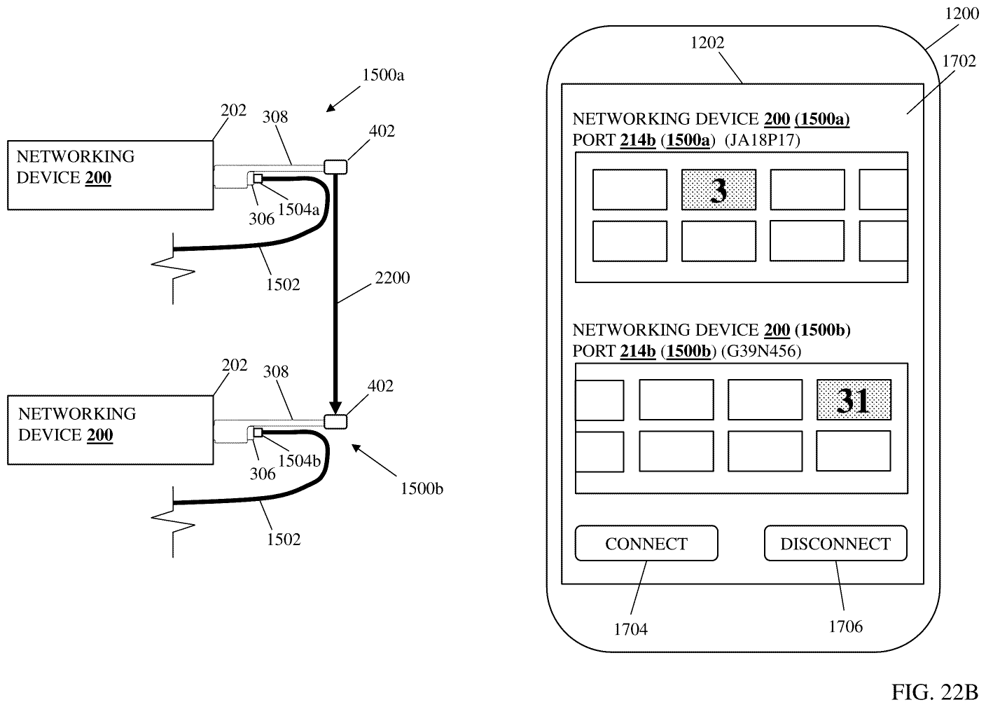

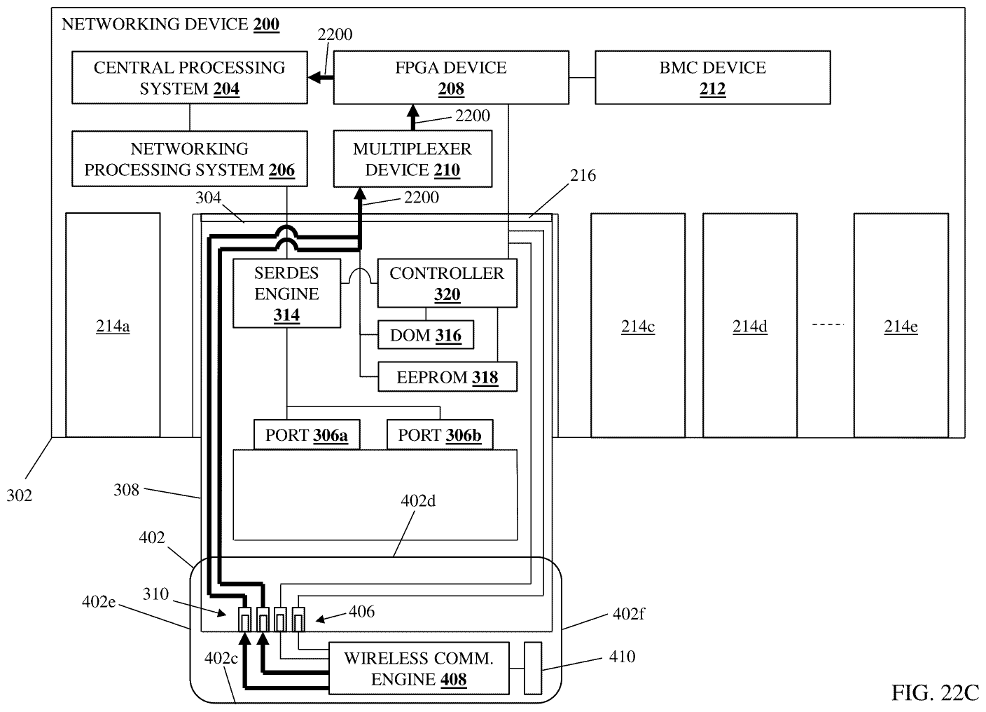

Further still, as illustrated in FIGS. 22A, 22B, and 22C, the operating system provided by the central processing system 204 (or the BMC device 212) in the networking device 200 in the wireless transceiver information provisioning system 1500a may perform command transmission operations 2200 to transmit commands via the peer wireless connection 1902 provided by its wireless transceiver information provisioning device 400 (e.g., via its FGPA device 208, its multiplexer device 210, its transceiver device 300, and its wireless communication engine 408) to the operating system provided by the central processing system 204 (or the BMC device 212) in the networking device 200 in the wireless transceiver information provisioning system 1500b (e.g., via its wireless communication engine 408, its transceiver device 300, its multiplexer device 210, and via its FGPA device 208) to cause the operating system provided by the central processing system 204 (or the BMC device 212) in the networking device 200 in the wireless transceiver information provisioning system 1500b to modify its port settings and/or other configuration in order to make link provided by the cable 1502 available.

However, while the use of wireless transceiver information provisioning devices of the present disclosure to provide wireless transceiver information provisioning systems in order to recover a link has been described, one of skill in the art in possession of the present disclosure will appreciate how other uses of the wireless transceiver information provisioning devices of the present disclosure to provide wireless transceiver information provisioning systems will fall within the scope of the present disclosure as well. For example, in situations in which a link is available between networking devices (i.e., via respective transceiver devices connected to their respective ports and a cable connected thereto), the wireless transceiver information provisioning devices may be used to provide wireless transceiver information provisioning systems and establish a peer wireless connection between the two similarly as described above with reference to FIGS. 15-19, and that peer wireless connection may then be used by the operating system provided by the central processing system in either of those networking devices to determine whether that link conforms to a desired link identified in a predefined topology/wiring diagram (i.e., whether the available link is provided between the networking devices, their ports, and their transceiver devices as defined by the predefined topology/wiring diagram). As such, one of skill in the art in possession of the present disclosure will appreciate how the peer wireless connection provided between wireless transceiver information provisioning systems as described above may be used in a variety of manners that will fall within the scope of the present disclosure.

Thus, systems and methods have been described that provide a wireless transceiver information provisioning device that may be connected to a transceiver that is connected to a port on a computing device, and then retrieve and wirelessly transmit transceiver information associated with that transceiver device to a wireless device. For example, the wireless transceiver information provisioning device of the present disclosure may include a wireless transceiver information provisioning device chassis, a transceiver device connector on the wireless transceiver information provisioning device chassis that is connected to a wireless transceiver information provisioning device connector on a transceiver device that is connected to a port, and a wireless communication subsystem housed in the wireless transceiver information provisioning device chassis and coupled to the transceiver device connector. The wireless communication subsystem receives transceiver information associated with the transceiver device via the transceiver device connector, and stores the first transceiver information. When the wireless communication subsystem wirelessly subsequently receives a transceiver information request from a wireless device, it wirelessly transmit the transceiver information to the wireless device. As such, transceiver information associated with transceiver devices may be retrieved without the issues with conventional transceiver information retrieval systems discussed above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A wireless transceiver information provisioning device, comprising:
a wireless transceiver information provisioning device chassis;
a transceiver device connector that is included on the wireless transceiver information provisioning device chassis and that is configured to be connected to a wireless transceiver information provisioning device connector on a transceiver device that is connected to a port; and
a wireless communication subsystem that is housed in the wireless transceiver information provisioning device chassis and coupled to the transceiver device connector, wherein the wireless communication subsystem is configured to:
receive, via the transceiver device connector when the transceiver device connector is connected to a first wireless transceiver information provisioning device connector on a first transceiver device that is connected to a first port, first transceiver information associated with the first transceiver device;
store the first transceiver information;
wirelessly receive, from a first wireless device, a transceiver information request; and
wirelessly transmit, to the first wireless device in response to receiving the transceiver information request, the first transceiver information.

2. The device of claim 1, wherein the wireless transceiver information provisioning device chassis defines a transceiver device handle channel, the transceiver device connector is included in the transceiver device handle channel, and the transceiver device handle channel is configured to receive a transceiver device handle on a transceiver device that includes a wireless transceiver information provisioning device connector to connect the transceiver device connector to that wireless transceiver information provisioning device connector.

3. The device of claim 1, wherein the wireless communication subsystem is configured to:
receive, via the transceiver device connector when the transceiver device connector is connected to the first wireless transceiver information provisioning device connector on the first transceiver device that is connected to the first port, power.

4. The device of claim 1, wherein the first transceiver information includes at least one of:
transceiver device information for the first transceiver device;
port information for the first port; and
computing device information for a computing device that includes the first port.

5. The device of claim 1, wherein the wireless communication subsystem is configured to:
wirelessly receive, from the first wireless device, a peer wireless connection establishment instruction;
establish, in response to receiving the peer wireless connection establishment instruction, a peer wireless connection with a peer wireless transceiver information provisioning device; and
wirelessly transmit, to the peer wireless transceiver information provisioning device subsequent to establishing the peer wireless connection, the first transceiver information.

6. The device of claim 1, wherein the wireless communication subsystem is configured to:
wirelessly receive, from the first wireless device, a peer wireless connection establishment instruction;
establish, in response to receiving the peer wireless connection establishment instruction, a peer wireless connection with a peer wireless transceiver information provisioning device; and
wirelessly receive, from the peer wireless transceiver information provisioning device subsequent to establishing the peer wireless connection, second transceiver information for a second transceiver device that is connected to the peer wireless transceiver information provisioning device.

7. A wireless transceiver information provisioning system, comprising:
a computing device including a first port;
a first transceiver device that is connected to the first port and that includes a first wireless transceiver information provisioning device connector; and
a first wireless transceiver information provisioning device that includes a transceiver device connector that is connected to the first wireless transceiver information provisioning device connector, wherein the wireless transceiver information provisioning device is configured to:
receive, via the transceiver device connector, first transceiver information associated with the first transceiver device;
store the first transceiver information;
wirelessly receive, from a first wireless device, a transceiver information request; and
wirelessly transmit, to the first wireless device in response to receiving the transceiver information request, the first transceiver information.

8. The system of claim 7, wherein the first wireless transceiver information provisioning device defines a transceiver device handle channel, the transceiver device connector is included in the transceiver device handle channel, a transceiver device handle on the first transceiver device is located in the transceiver device handle channel, and the wireless transceiver information provisioning device connector is located on the transceiver device handle and connected to the transceiver device connector.

9. The system of claim 7, wherein the first wireless transceiver information provisioning device is configured to:
receive, via the transceiver device connector, power.

10. The system of claim 7, wherein the first transceiver information includes at least one of:
transceiver device information for the first transceiver device;
port information for the first port; and
computing device information for the computing device.

11. The system of claim 7, wherein the first wireless transceiver information provisioning device is configured to:
wirelessly receive, from the first wireless device, a peer wireless connection establishment instruction;
establish, in response to receiving the peer wireless connection establishment instruction, a peer wireless connection with a second wireless transceiver information provisioning device; and
wirelessly transmit, to the second wireless transceiver information provisioning device subsequent to establishing the peer wireless connection, the first transceiver information.

12. The system of claim 7, wherein the first wireless transceiver information provisioning device is configured to:
wirelessly receive, from the first wireless device, a peer wireless connection establishment instruction;
establish, in response to receiving the peer wireless connection establishment instruction, a peer wireless connection with a second wireless transceiver information provisioning device; and
wirelessly receive, from the second wireless transceiver information provisioning device subsequent to establishing the peer wireless connection, second transceiver information for a second transceiver device that is connected to the second wireless transceiver information provisioning device.

13. The system of claim 12, further comprising:
an operating system that is provided in the computing device and that is configured to:
retrieve the first transceiver information and the second transceiver information from the first wireless transceiver information provisioning device; and
generate, based on at least one of the first transceiver information and the second transceiver information, link recovery instructions for a link between the first transceiver device and the second transceiver device.

14. A method for wirelessly providing information about a transceiver device, comprising:
connecting, by a first wireless transceiver information provisioning device via a transceiver device connector on the first wireless transceiver information provisioning device, to a first wireless transceiver information provisioning device connector on a first transceiver device that is connected to a first port on a computing device;
receiving, by the first wireless transceiver information provisioning device via the transceiver device connector, first transceiver information associated with the first transceiver device;
storing, by the first wireless transceiver information provisioning device, the first transceiver information;
wirelessly receiving, by the first wireless transceiver information provisioning device from a first wireless device, a transceiver information request; and
wirelessly transmitting, by the first wireless transceiver information provisioning device to the first wireless device in response to receiving the transceiver information request, the first transceiver information.

15. The method of claim 14, wherein the first wireless transceiver information provisioning device defines a transceiver device handle channel, the transceiver device connector is included in the transceiver device handle channel, a transceiver device handle on the first transceiver device is located in the transceiver device handle channel, and the wireless transceiver information provisioning device connector is located on the transceiver device handle and connected to the transceiver device connector.

16. The method of claim 14, further comprising:
receiving, by the first wireless transceiver information provisioning device via the transceiver device connector, power.

17. The method of claim 14, wherein the first transceiver information includes at least one of:
transceiver device information for the first transceiver device;
port information for the first port; and
computing device information for the computing device.

18. The method of claim 14, further comprising:
wirelessly receiving, by the first wireless transceiver information provisioning device from the first wireless device, a peer wireless connection establishment instruction;
establishing, by the first wireless transceiver information provisioning device in response to receiving the peer wireless connection establishment instruction, a peer wireless connection with a second wireless transceiver information provisioning device; and
wirelessly transmitting, by the first wireless transceiver information provisioning device to the second wireless transceiver information provisioning device subsequent to establishing the peer wireless connection, the first transceiver information.

19. The method of claim 14, further comprising:
wirelessly receiving, by the first wireless transceiver information provisioning device from the first wireless device, a peer wireless connection establishment instruction;
establishing, by the first wireless transceiver information provisioning device in response to receiving the peer wireless connection establishment instruction, a peer wireless connection with a second wireless transceiver information provisioning device; and
wirelessly receiving, from the second wireless transceiver information provisioning device subsequent to establishing the peer wireless connection, second transceiver information for a second transceiver device that is connected to the second wireless transceiver information provisioning device.

20. The method of claim 14, further comprising:
retrieving, by an operating system that is provided in the computing device, the first transceiver information and the second transceiver information from the first wireless transceiver information provisioning device; and
generating, by the operating system based on at least one of the first transceiver information and the second transceiver information, link recovery instructions for a link between the first transceiver device and the second transceiver device.
